(19) United States
(12) Patent Application Publication
(10) Pub. No.: US 2025/0240131 A1
(43) Pub. Date: Jul. 24, 2025

(54) FREQUENCY HOPPING FOR REPETITIONS OF AN UPLINK MESSAGE TRANSMISSION IN A BANDWIDTH LIMITED USER EQUIPMENT

(71) Applicant: QUALCOMM Incorporated, San Diego, CA (US)

(72) Inventors: Hung Dinh LY, San Diego, CA (US); Yongjun KWAK, San Diego, CA (US); Kexin XIAO, Shanghai (CN)

(21) Appl. No.: 18/881,847

(22) PCT Filed: Aug. 11, 2022
(86) PCT No.: PCT/CN2022/111689

§ 371 Date: Jan. 7, 2025

(51) Int. Cl. H04L 5/00; H04L 1/00; H04L 1/08

(52) U.S. Cl. CPC H04L 5/0012; H04L 1/0013; H04L 1/08

(57) ABSTRACT

An apparatus for wireless communication receives information enabling one or more repetitions of an uplink message associated with a network access procedure, wherein a maximum bandwidth allocated to the apparatus is less than a bandwidth of an initial uplink bandwidth part of the apparatus, receives a frequency hopping indication for the one or more repetitions of the uplink message, and transmits the uplink message and the one or more repetitions of the uplink message in different slots using inter-slot frequency hopping based on at least the information and the frequency hopping indication, wherein the inter-slot frequency hopping includes multiple sub-bands of the initial uplink bandwidth part, and wherein a single sub-band of the multiple sub-bands is used in each of the different slots.

### BACKGROUND

### Technical Field

The present disclosure relates generally to communication systems, and more particularly, to frequency hopping for repetitions of an uplink message transmission in a bandwidth limited user equipment (UE).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A user equipment (UE) may be configured to perform a network access procedure, such a four-step random access channel (RACH) procedure, to achieve synchronization with a cell (e.g., with respect to time and frequency) and to obtain the cell ID of a cell. A UE may be configured to repeat one or more uplink (UL) messages of the network access procedure, such as message 3 (Msg3), on a physical uplink shared channel (PUSCH).

For repetition of a UL message (e.g., message 3 (Msg3)) of the network access procedure, inter-slot frequency hopping may be supported. For a UE with limited bandwidth (e.g., enhanced reduced capability (eRedCap) UE), if inter-slot frequency hopping is configured, the frequency hops used at the UE for transmissions may be contained within a sub-band of the initial UL bandwidth part (BWP) of the UE. However, such frequency hopping may not provide a sufficient frequency diversity gain due to the limited bandwidth of the sub-band.

In an aspect of the disclosure, a method, a computer-readable medium, and an apparatus are provided. The apparatus may be a UE. The apparatus receives information enabling one or more repetitions of an uplink message associated with a network access procedure, wherein a maximum bandwidth allocated to the apparatus is less than a bandwidth of an initial uplink bandwidth part of the apparatus, receives a frequency hopping indication for the one or more repetitions of the uplink message, and transmits the uplink message and the one or more repetitions of the uplink message in different slots using inter-slot frequency hopping based on at least the information and the frequency hopping indication, wherein the inter-slot frequency hopping includes multiple sub-bands of the initial uplink bandwidth part, and wherein a single sub-band of the multiple sub-bands is used in each of the different slots.

In an aspect of the disclosure, a method, a computer-readable medium, and an apparatus are provided. The apparatus may be a UE. The apparatus receives information enabling one or more repetitions of an uplink message associated with a network access procedure, wherein a maximum bandwidth allocated to the apparatus is less than a bandwidth of an initial uplink bandwidth part of the apparatus, receives a frequency hopping indication for the one or more repetitions of the uplink message, and transmits the uplink message and the one or more repetitions of the uplink message in different slots using inter-slot frequency hopping based on at least the information and the frequency hopping indication, wherein the inter-slot frequency hopping includes multiple portions of multiple sub-bands of the initial uplink bandwidth part, and wherein a single portion of the multiple portions is used in each of the different slots.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 shows a diagram illustrating an example disaggregated base station architecture.

FIG. 5 is a signal flow diagram illustrating an example four-step random access channel (RACH) procedure performed between a UE and a network node.

FIG. 6 illustrates examples of long sequence-based random access channel (RACH) preamble formats.

FIG. 7 illustrates examples of short sequence-based RACH preamble formats.

FIG. 8 is a diagram illustrating an initial uplink (UL) bandwidth part (BWP) of a UE.

FIG. 9 is a diagram illustrating the initial UL BWP of a UE as described with reference to FIG. 8 after partitioning of the initial UL BWP into multiple sub-bands.

FIG. 10 is a diagram illustrating the multiple sub-bands of the initial UL BWP of a UE as described with reference to FIG. 9 and the frequency offsets defining one or more of the multiple sub-bands.

FIG. 11 is a diagram illustrating intra-slot frequency hopping for a message 3 (Msg3) transmission and a repetition of the message 3 (Msg3) transmission.

FIG. 12 is a signal flow diagram in accordance with various aspects of the disclosure.

FIG. 13 illustrates an example of a first frequency hop and a second frequency hop of an initial UL BWP for inter-slot frequency hopping, where the inter-slot frequency hopping includes multiple sub-bands of the initial UL BWP in accordance with various aspects of the disclosure.

FIG. 14 is a diagram illustrating inter-slot frequency hopping between multiple sub-bands of an initial UL BWP in accordance with various aspects of the disclosure.

FIG. 15 is a signal flow diagram in accordance with various aspects of the disclosure.

FIG. 16 is a diagram illustrating an initial UL BWP of a UE, multiple sub-bands of the initial UL BWP, and multiple frequency hops including multiple portions of a first sub-band and multiple portions of a second sub-band.

FIG. 17 is a diagram illustrating inter-slot frequency hopping within a same sub-band of the initial UL BWP followed by inter-slot frequency hopping within a different sub-band of the initial UL BWP.

FIG. 18 is a diagram illustrating inter-slot frequency hopping by alternating between sub-bands of the initial UL BWP and the multiple portions of the sub-bands for successive slots.

FIG. 19 is a flow chart of a method of wireless communication.

FIG. 20 is a flow chart of a method of wireless communication.

FIG. 21 is a conceptual data flow diagram illustrating the data flow between different means/components in an example apparatus.

FIG. 22 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

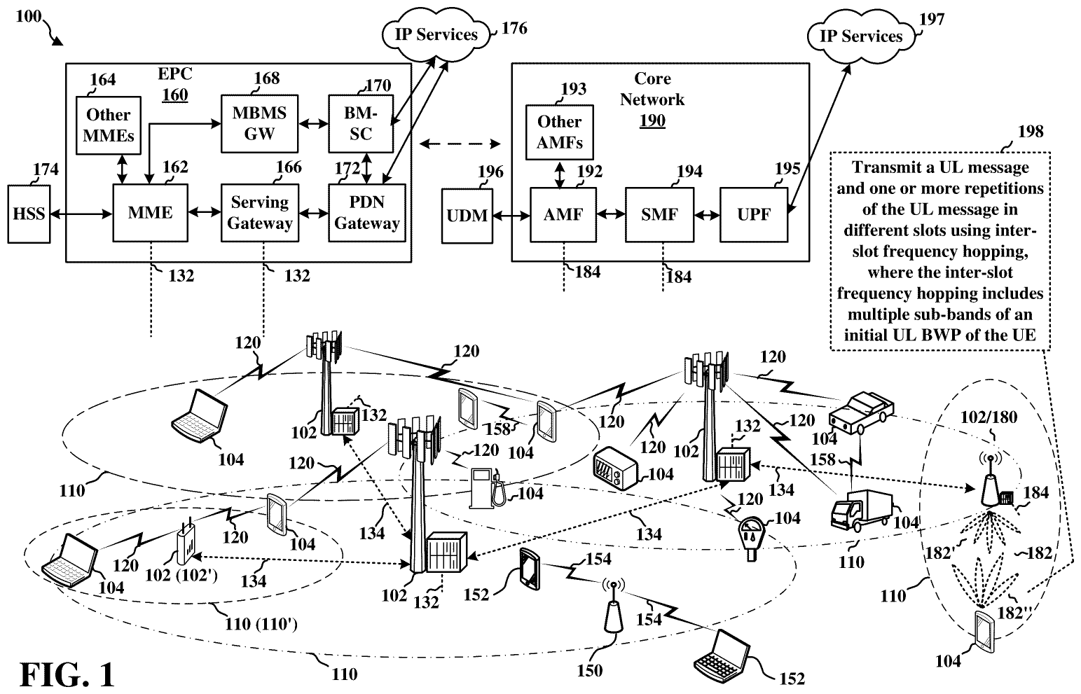

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to transmit a UL message and one or more repetitions of the UL message in different slots using inter-slot frequency hopping, where the inter-slot frequency hopping includes multiple sub-bands of an initial UL BWP of the UE 104 (198). Although the following description may be focused on 5G NR, the concepts described herein may be applicable to other similar areas, such as LTE, LTE-A, CDMA, GSM, and other wireless technologies.

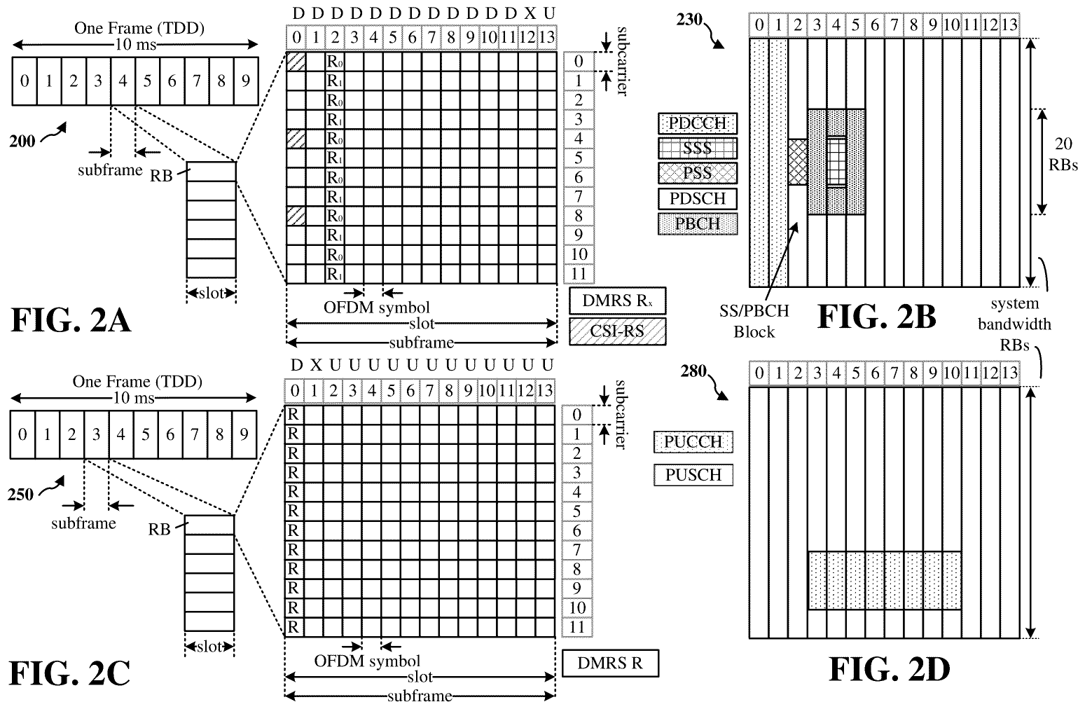

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (abbreviated herein as “SSB”). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

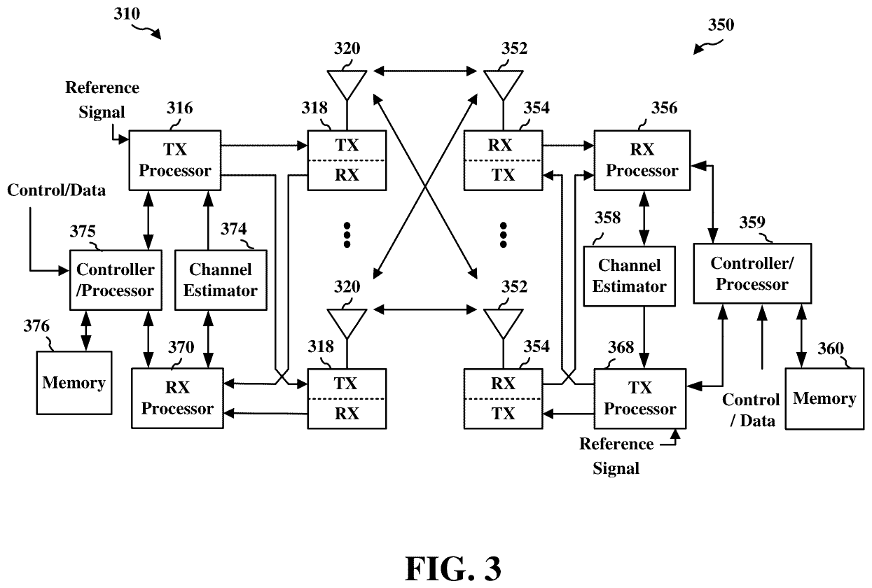

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

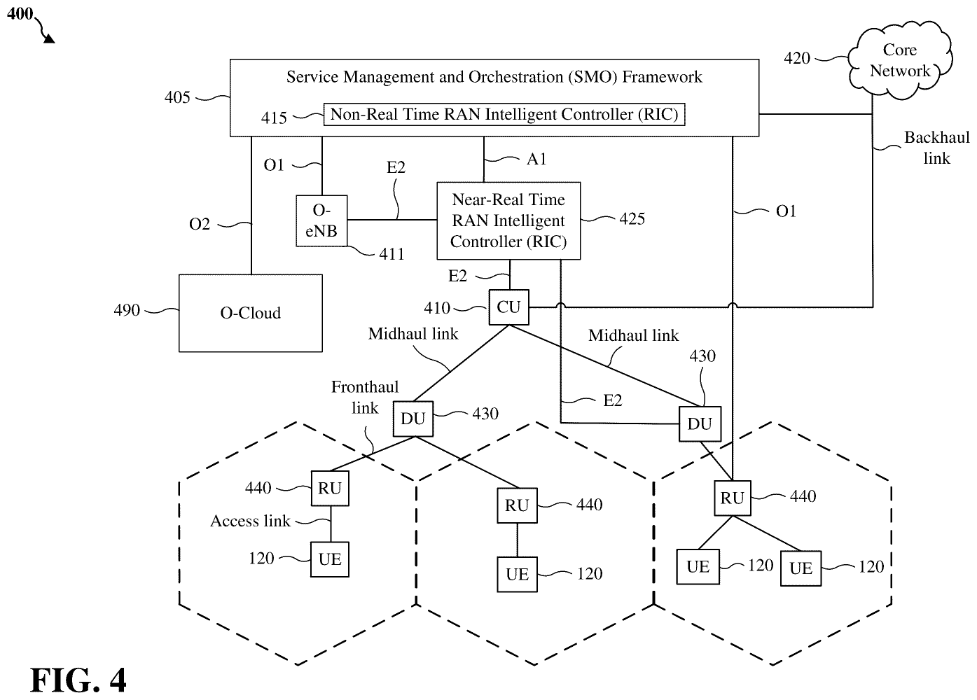

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 120 via one or more radio frequency (RF) access links. In some implementations, the UE 120 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 120. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

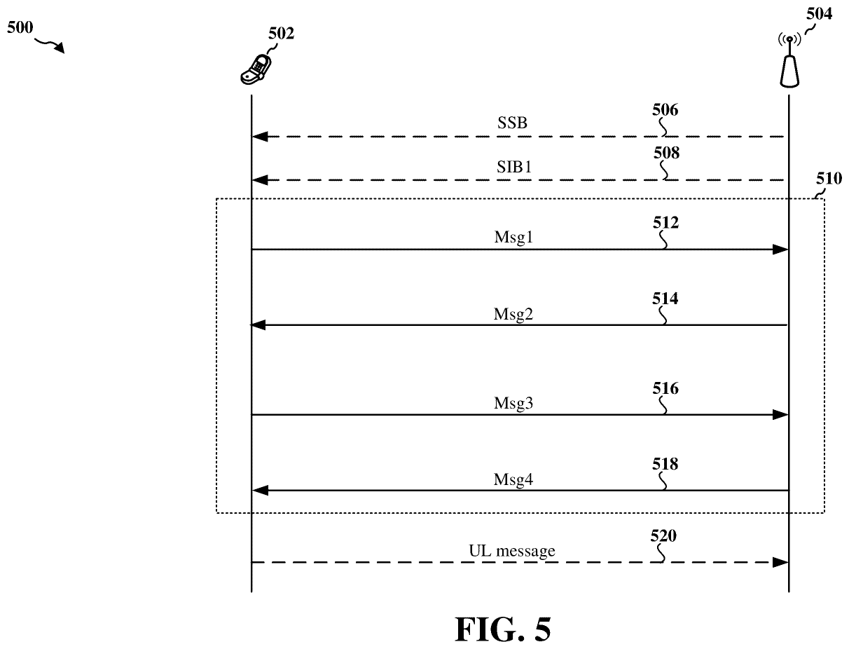

FIG. 5 is a signal flow diagram 500 illustrating an example four-step random access channel (RACH) procedure 510 performed between a UE 502 and a network node 504. The network node 504 may be a base station. The four-step RACH procedure 510 may be a contention-based random access procedure (CBRA) and may be initiated by the UE 502 for initial access to a network (e.g., to achieve UL synchronization with the network node 504).

The UE 502 may receive an SSB 506 and a system information block (SIB), such as a SIB1 508. The SIB1 508 may include RACH configuration information. The UE 502 may receive the SIB1 508 using PDSCH resources indicated by the PDCCH.

The UE 502 may initiate the four-step RACH procedure 510 by transmitting a PRACH preamble in message 1 (Msg1) 512. Message 1 (Msg1) 512 may be referred to as a random access message and may be the initial message of the four-step RACH procedure 510. Upon detection of the PRACH preamble, the network node 504 responds with message 2 (Msg2) 514 including a random access response (RAR). The network node 504 may use a PDCCH for scheduling and a PDSCH for transmission of message 2 (Msg2) 514. Message 2 514 may include a timing advance, a UL grant for transmission of message 3 (Msg3) 516 by the UE 502 using the PUSCH, and a temporary cell radio network temporary identifier (TC-RNTI).

The UE 502 may transmit message 3 (Msg3) 516 using the PUSCH. Message 3 (Msg3) 516 may include an RRC connection request, a scheduling request, a buffer status, and/or other information (e.g., small data). The network node 504 may transmit a contention resolution via message 4 (Msg4) 518 using the PDCCH for scheduling and the PDSCH for transmission of message 4 (Msg4) 518. The UE 502 may optionally transmit a UL message 520 (e.g., on the PUCCH or PDSCH).

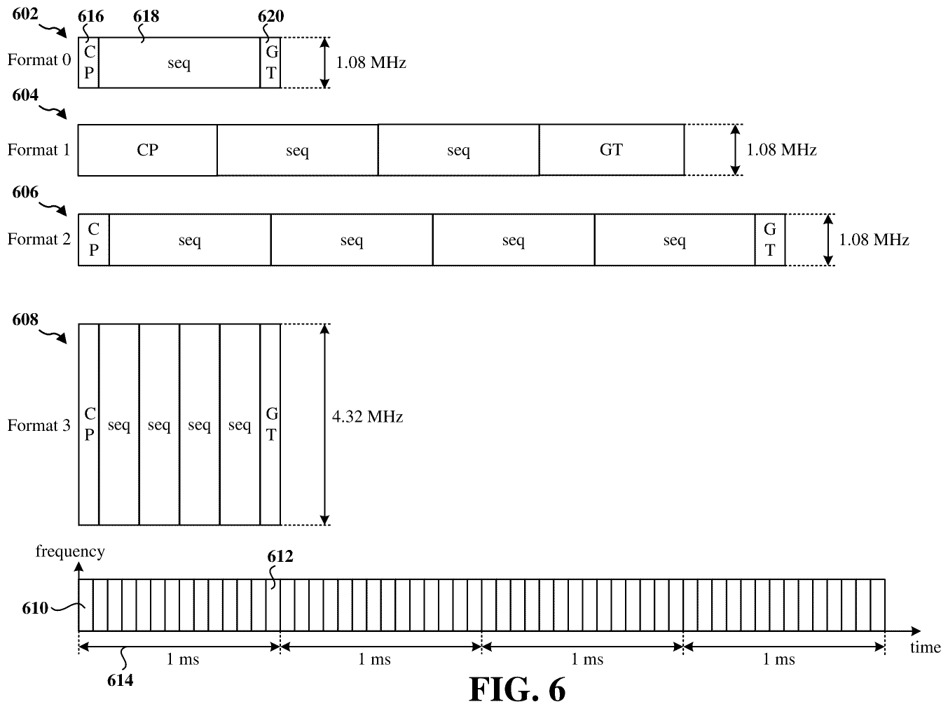

FIG. 6 illustrates examples of long sequence-based RACH preamble formats, such as format 0 602, format 1 604, format 2 606, format 3 608. Each of the long sequence-based RACH preamble formats (e.g., format 0 602, format 1 604, format 2 606, format 3 608) in FIG. 6 may have a length 839 (e.g., L=839). The NR frequency range (FR1) PRACH bandwidth of format 0 602, format 1 604, format 2 606 may be 1.08 MHz and the NR FR1 PRACH bandwidth of format 3 608 may be 4.32 MHz. Each of the long sequence-based RACH preamble formats in FIG. 6 includes a cyclic prefix (e.g., CP 616), one or more sequences (e.g., sequence (seq) 618) and a guard time (e.g., GT 620).

FIG. 6 further illustrates a number of slots, such as slot 614, having a duration of 1 ms. Each slot may include 14 symbols (e.g., OFDM symbols), such a first symbol 610 and a fourteenth symbol 612.

The long-sequence based preamble formats shown in FIG. 6 may enable a UE to perform long transmissions (e.g., 1 ms or longer) with a relatively narrow bandwidth. It should be noted that the NR FR1 PRACH bandwidths of the long-sequence based preamble formats shown in FIG. 6 may be smaller than a maximum bandwidth (e.g., 5 MHz) of a UE (e.g., an enhanced reduced capability (eRedCap) UE).

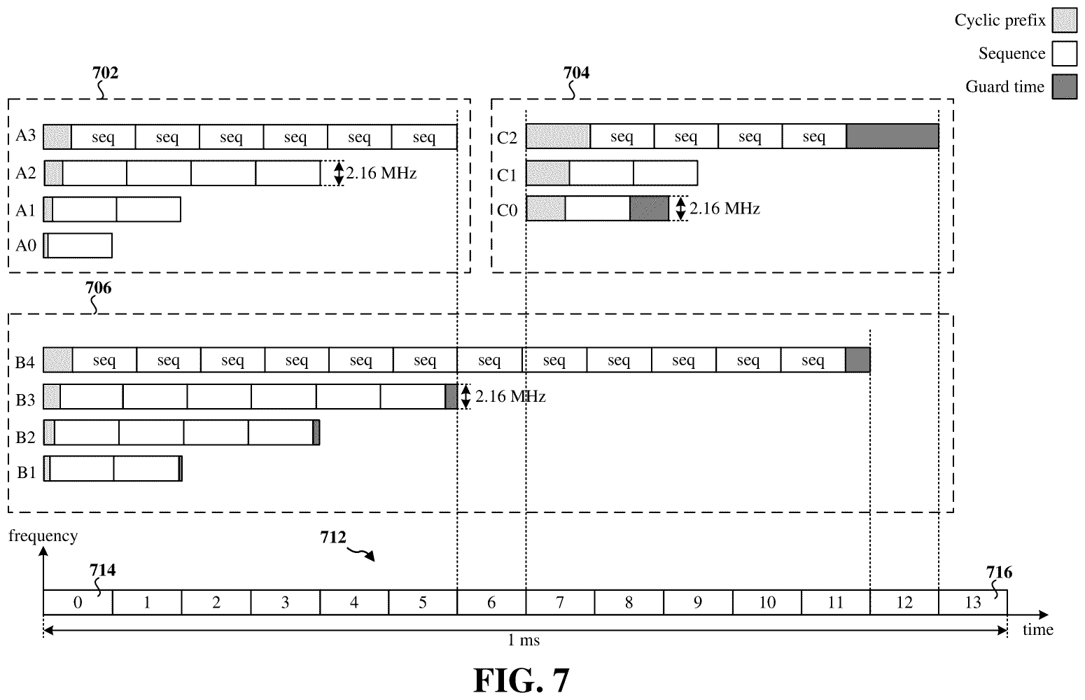

FIG. 7 illustrates examples of short sequence-based RACH preamble formats 702, 704 706. As shown in FIG. 7, the short sequence-based RACH preamble formats 702 include formats A0, A1, A2, A3, the short sequence-based RACH preamble formats 704 include formats C0, C1, C2, and the short sequence-based RACH preamble formats 706 include formats B1, B2, B3, B4. The short sequence-based RACH preamble formats 702, 704 706 in FIG. 7 may have a length 139 (e.g., L=139).

The NR FR1 PRACH bandwidth of the short sequence-based RACH preamble formats 702, 704 706 may be 2.16 MHz with a subcarrier spacing (SCS) of 15 kHz. For example, the NR FR1 PRACH bandwidth of the short sequence-based RACH preamble formats 702, 704 706 may be 4.32 MHz if the subcarrier spacing (SCS) is increased to 30 kHz.

FIG. 7 further illustrates a slot 712 having a duration of 1 ms. The slot 712 may include 14 symbols (e.g., OFDM symbols), such a first symbol 714 (e.g., symbol 0) and a fourteenth symbol 716 (e.g., symbol 13).

The short-sequence based preamble formats shown in FIG. 7 may enable a UE to perform short transmissions (e.g., transmissions of 2, 4, 6, or 12 OFDM symbols) with CP aggregated at the beginning of the burst and with or without a guard time (GT) at the end. It should be noted that the NR FR1 PRACH bandwidths of the short sequence-based preamble formats shown in FIG. 7 may be smaller than a maximum bandwidth (e.g., 5 MHz) of a UE (e.g., an eRedCap UE).

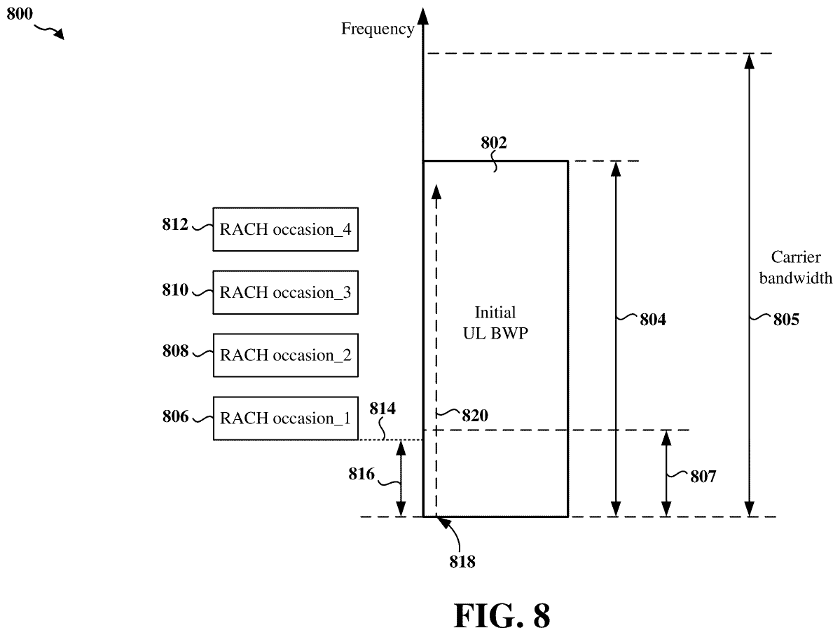

FIG. 8 is a diagram 800 illustrating an initial UL bandwidth part (BWP) 802 of a UE. The initial UL BWP 802 may have a bandwidth 804. For example, the bandwidth 804 of the initial UL BWP 802 may be less than a full bandwidth 805 of a carrier (also referred to as carrier bandwidth). A UE may receive a configuration of the initial UL BWP 802 via a system information block (SIB), such as SIB1.

In some examples, the initial UL BWP 802 configured for a UE may include RACH occasions (e.g., RACH occasion_1 806, RACH occasion_2 808, RACH occasion_3 810, RACH occasion_4 812 shown in FIG. 8) and a resource allocation in the frequency domain for one or more UL message transmissions (e.g., a transmission of a UL message of an initial access procedure, such as Msg3 516 described with reference to FIG. 5) on PUSCH.

As shown in FIG. 8, a UE may be configured with a frequency location of a first RACH occasion, such as the RACH occasion_1 806, based on an offset 816 from a starting resource block (RB) 818 (e.g., PRB0) of the initial UL BWP 802. For example, the frequency at 814 may be referred to as msg1-FrequencyStart. The PUSCH resource mapping in the frequency domain may begin at the starting RB 818 (e.g., PRB0) of the initial UL BWP 802. In FIG. 8, the arrow 820 represents the frequency domain resource allocation (FDRA) from the starting RB 818 (e.g., PRB0).

Some types of UEs may have different capabilities relative to other types of UEs. For example, some types of UEs, such as premium smartphones, may have high performance capabilities (e.g., eMBB/URLLC capabilities). Other types of UEs, such as health monitors, low-end smartphones, industrial wireless sensors, video surveillance devices, high-end wearables, and high-end asset trackers may have reduced capabilities. These types of UEs may be referred to as reduced capability (RedCap) UEs and may have lower performance capabilities (e.g., capabilities between eMBB and Low Power Wide Area (LPWA)). Yet other types of UEs, such as parking sensors, low-end industrial sensors, agriculture sensors, utility meters, low-end wearables, and low-end asset trackers, may have further reduced capabilities. These types of UEs may be referred to as enhanced RedCap (eRedCap) UEs and may have lower performance capabilities (e.g., capabilities including massive Internet of things (IoT), LPWA) than RedCap UEs.

For eRedCap UEs, the maximum bandwidth size 807 of the initial UL BWP 802 may be significantly less than the maximum bandwidth size that may be allocated for RedCap UEs and/or premium UEs (e.g., smartphones). For example, the full bandwidth 804 of the initial UL BWP 802 allocated to a premium UE may be 20 MHz (or higher), while the maximum bandwidth size 807 of the initial UL BWP 802 allocated to an eRedCap UE may be 5 MHz. The maximum bandwidth size 807 may include one or two RACH occasions depending on the subcarrier spacing (SCS) of the PRACH.

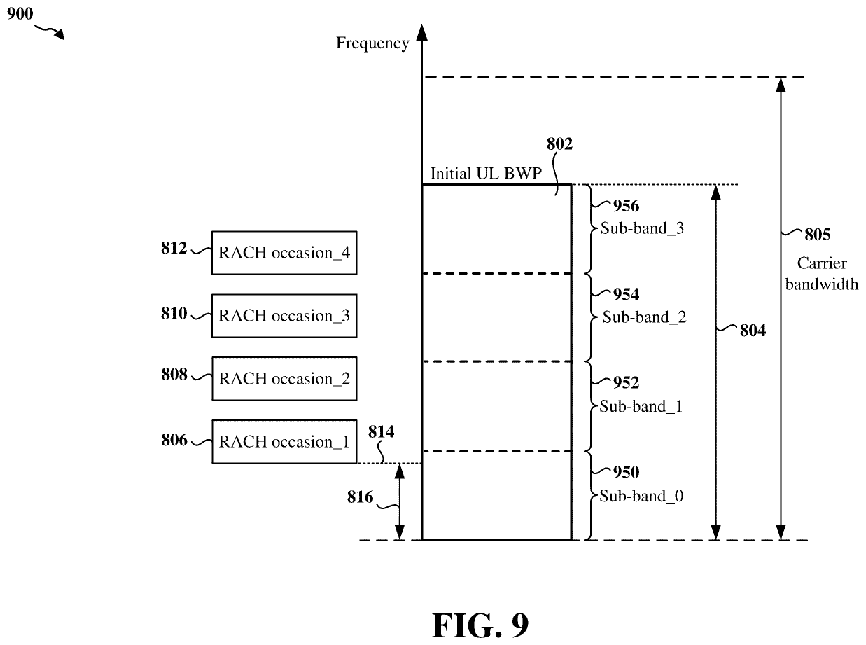

FIG. 9 is a diagram 900 illustrating the initial UL BWP 802 of a UE as described with reference to FIG. 8 after partitioning of the initial UL BWP 802 into multiple sub-bands. For example, the initial UL BWP 802 may be partitioned into four sub-bands including sub-band_0 950, sub-band_1 952, sub-band_2 954, and sub-band_3 956. Although the initial UL BWP 802 in FIG. 9 is partitioned into four sub-bands, it should be understood that the initial UL BWP 802 may be partitioned into a different number of sub-bands in other examples.

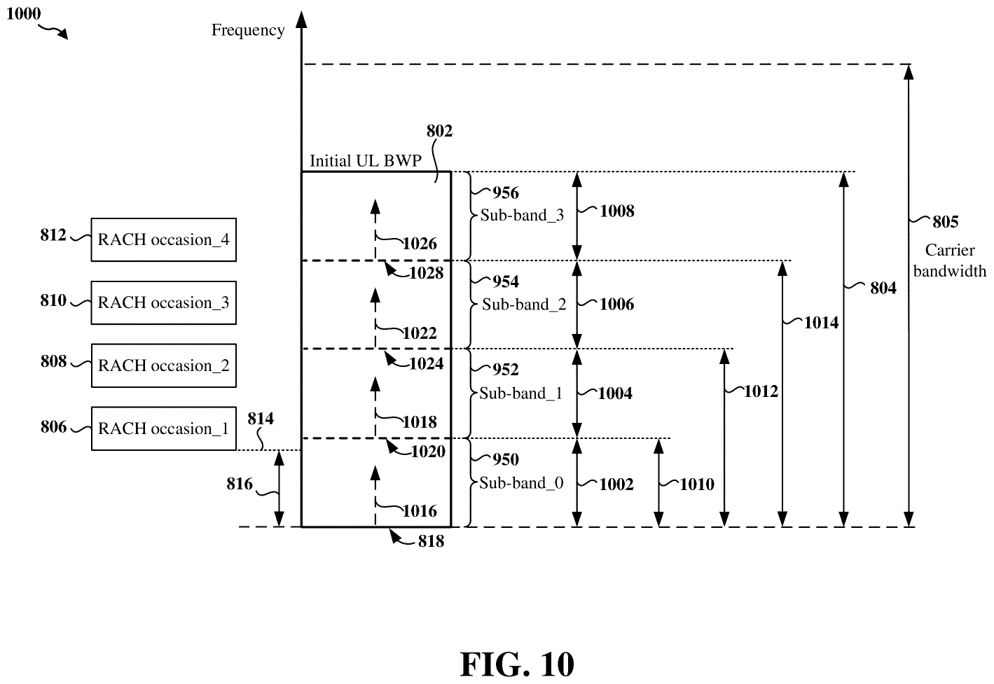

FIG. 10 is a diagram 1000 illustrating the multiple sub-bands of the initial UL BWP 802 of a UE as described with reference to FIG. 9 and the frequency offsets defining one or more of the multiple sub-bands. In some examples, each of the multiple sub-bands (e.g., sub-band_0 950, sub-band_1 952, sub-band_2 954, and sub-band_3 956) may have the same bandwidth. For example, if the full bandwidth 804 of the initial UL BWP 802 is 20 MHz, each of the bandwidths 1002, 1004, 1006, 1008 may be 5 MHz.

As shown in FIG. 10, a first frequency offset 1010 may define a beginning of sub-band_1 952, a second frequency offset 1012 may define a beginning of sub-band_2 954, and a third frequency offset 1014 may define a beginning of sub-band_3 956. Each of the frequency offsets (e.g., the first, second, and third frequency offsets 1010, 1012, 1014) may be determined with respect to the starting RB 818 (e.g., PRB0) of the initial UL BWP 802 and based on the SCS of the initial UL BWP 802.

In some examples, each of the frequency offsets (e.g., the first, second, and third frequency offsets 1010, 1012, 1014) may be indicated to a UE in system information (SI). In some examples, each of the frequency offsets (e.g., the first, second, and third frequency offsets 1010, 1012, 1014) may be determined based on the maximum bandwidth allocated to a UE. For example, a frequency offset k may be k·N_{rb} where N_{rb} is the number of RBs contained in the maximum bandwidth of a UE. A sub-band may be considered valid if it contains a threshold number of RBs (e.g., N_{rb}).

A frequency domain resource allocation (FDRA) for a UL message transmission (e.g., a Msg3 transmission) on the PUSCH may begin at the first RB in a valid sub-band. For example, a first FDRA 1016 may begin at the starting RB 818 of sub-band_0 950, a second FDRA 1018 may begin at the first RB 1020 of sub-band_1 952, a third FDRA 1022 may begin at the first RB 1024 of sub-band_2 954, and a fourth FDRA 1026 may begin at the first RB 1028 of sub-band_3 956.

In some examples, a UE may be scheduled for an initial message 3 (Msg3) transmission on the PUSCH via a UL grant in a random access response (RAR) message (e.g., a message 2 (Msg2) transmission). The UE may be scheduled for one or more retransmissions (also referred to as repetitions) of the message 3 (Msg3) transmission via DCI (e.g., DCI format 0_0) with CRC scrambled by a Temporary Cell RNTI (TC-RNTI) provided in the corresponding RAR message.

In other examples, a UE may support Type A PUSCH repetitions of a message 3 (Msg3) transmission. A UE may further support inter-slot frequency hopping for a message 3 (Msg3) transmission and one or more repetitions of the message 3 (Msg3) transmission. A UE may support intra-slot frequency hopping when the UE is scheduled for a message 3 (Msg3) transmission on the PUSCH without repetition.

If a UE receives repetition information enabling transmission of one or more repetitions of a message 3 (Msg3) transmission on the PUSCH, a frequency hopping flag information field in a UL grant of an RAR message or in DCI format 0_0 with CRC scrambled by TC-RNTI may be used to enable/disable inter-slot frequency hopping. A UL grant in an RAR message may include one or more fields (also referred to as RAR grant fields). As shown in Table 1 below, the RAR grant fields of a UL grant may include a frequency hopping flag, a PUSCH frequency resource allocation (e.g., a frequency resource allocation on PUSCH for a message 3 (Msg3) transmission), a PUSCH time resource allocation (e.g., a time resource allocation on PUSCH for a message 3 (msg3) transmission), a modulation and coding scheme (MCS), a transmit power control (TPC) command for PUSCH, a channel state information (CSI) request, and a channel access type and CP extension (ChannelAccess-CPext).

In some examples, the PUSCH frequency resource allocation field in Table 1 may be 14 bits for operation without shared spectrum channel access or 12 bits for operation with shared spectrum channel access. In some examples, the ChannelAccess-CPext field in Table 1 may be 0 bits for operation without shared spectrum channel access or 2 bits for operation with shared spectrum channel access.

TABLE 1

| RAR grant field | Number of bits |
|---|---|
| Frequency hopping flag | 1 |
| PUSCH frequency resource allocation | 14 or 12 |
| PUSCH time resource allocation | 4 |
| MCS | 4 |
| TPC command for PUSCH | 3 |
| CSI request | 1 |
| ChannelAccess-CPext | 0 or 2 |

A DCI format 0_0 with CRC scrambled by TC-RNTI may include a 1-bit field for an identifier of a DCI format, a 4-bit field for a time domain resource assignment, a 1-bit field for a frequency hopping flag, a 5-bit field for a modulation and coding scheme (MCS), and a 1-bit reserved field referred to as a new data indicator.

When the UE is configured to perform inter-slot frequency hopping for one or more repetitions of a UL message transmission (e.g., a message 3 (Msg3) transmission) on the PUSCH, the UE may apply a frequency offset configuration as described herein with reference to Table 2. For example, the UE may apply Table 2 to determine an RB offset for each slot. The UE may apply an additional DMRS configuration for the UL message transmission (e.g., a message 3 (Msg3) transmission) on the PUSCH in case intra-slot frequency hopping is disabled. The UE may apply an inter-slot frequency hopping pattern defined for PUSCH repetition type A.

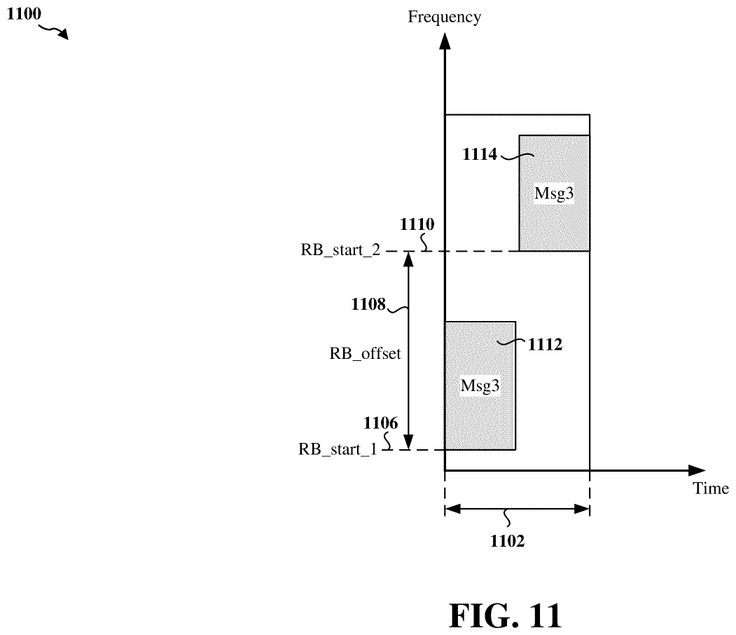

FIG. 11 is a diagram 1100 illustrating intra-slot frequency hopping for a message 3 (Msg3) transmission and a repetition of the message 3 (Msg3) transmission. As shown in FIG. 11, a UE may perform an initial message 3 (Msg3) transmission 1112 and a repetition 1114 of the initial message 3 (Msg3) transmission 1112 within a slot 1102. The UE may be configured to perform the initial message 3 (Msg3) transmission 1112 using a first set of RBs beginning at a first RB (e.g., RB_start_1) 1106 and may perform the repetition 1114 of the initial message 3 (Msg3) transmission 1112 using a second set of RBs beginning at a second RB (e.g., RB_start_2) 1110. As shown in FIG. 11, the UE may determine the second RB (e.g., RB_start_2) 1110 based on an RB offset (RB_offset) 1108.

A UE may be configured to perform the intra-slot frequency hopping shown in FIG. 11 via an RAR message (e.g., a message 2 (Msg2) transmission) received for the initial message 3 (Msg3) transmission 1112 or in DCI format 0_0 with CRC scrambled by TC-RNTI for the repetition 1114 of the initial message 3 (Msg3) transmission 1112.

The UE may support intra-slot frequency hopping when the UE is scheduled for a message 3 (Msg3) transmission on the PUSCH without repetition. If the UE receives repetition information enabling transmission of one or more repetitions of a message 3 (Msg3) transmission on the PUSCH, a frequency hopping flag information field in a UL grant of an RAR message or in DCI format 0_0 with CRC scrambled by TC-RNTI may be used to enable/disable inter-slot frequency hopping. The value of the RB offset 1108 for a second hop may depend on the size of the initial uplink BWP configured for the UE.

Table 2 includes a frequency offset configuration which a UE may use for frequency hopping when transmitting a UL message on the PUSCH scheduled by a UL grant in an RAR message or when transmitting repetitions of the UL message (e.g., one or more repetitions of a message 3 (Msg3) transmission) on the PUSCH. In Table 2, N_{BWP}^{size} represents the number of PRBs in the initial UL BWP of the UE and N_{UL,hop} is an RRC value received from the network. For example, when N_{UL,hop} is set to 0, the offset may be half of the initial UL BWP. When N_{UL,hop} is set to 1, the offset is one quarter of the initial UL BWP.

In one example, there may be two possible frequency offsets when the initial UL BWP configured for the UE includes less than 50 RBs. In another example, there may be four possible frequency offsets when the initial UL BWP configured for the UE includes 50 or more RBs.

TABLE 2

| Number of PRBs in | Value of N_{UL, hop} | Frequency offset |
|---|---|---|
| initial UL BWP | hopping bits | for 2^{nd} hop |
| N_{BWP}^{size} < 50 | 0 | [N_{BWP}^{size}/2] |
| | 1 | [N_{BWP}^{size}/4] |
| N_{BWP}^{size} ≥ 50 | 00 | [N_{BWP}^{size}/2] |
| | 01 | [N_{BWP}^{size}/4] |
| | 10 | −[N_{BWP}^{size}/4] |
| | 11 | Reserved |

In the case of intra-slot frequency hopping, the beginning RB (also referred to as the starting RB) in each hop is given by equation (1):

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad ( equation 1 )$$

where i=0 and i=1 are the first hop and the second hop respectively, RBₛₜₐᵣₜ is the starting RB within the UL BWP, as determined from the resource block assignment information of resource allocation type 1 or as determined from the resource assignment for message A (MsgA) PUSCH, and RB_{offset} is the frequency offset in RBs between the two frequency hops. The number of symbols in the first hop is given by [N_{sumb}^{PUSCH,s}/2], the number of symbols in the second hop is given by N_{symb}^{PUSCH,s}−[N_{sumb}^{PUSCH,s}/2], where N_{symb}^{PUSCH,s} is the length of the PUSCH transmission in OFDM symbols in one slot.

In the case of inter-slot frequency hopping, the starting RB during slot nₛ^{μ} is given by equation (2):

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad ( equation 2 )$$

where nₛ^{μ} is the current slot number within a radio frame, where a multi-slot PUSCH transmission can take place, RBₛₜₐᵣₜ is the starting RB within the UL BWP, as determined from the resource block assignment information of resource allocation type 1 and RB_{offset} is the frequency offset in RBs between the two frequency hops.

Some wireless communication networks may support repetition of a message 3 (Msg3) transmission (e.g., repetition of Msg3 516 described with reference to FIG. 5) at a UE on the PUSCH using inter-slot frequency hopping. If the maximum bandwidth allocated to a UE is a sub-band of the initial UL BWP configured for the UE (e.g., if the maximum bandwidth (e.g., 5 MHz) allocated to a UE is less than the bandwidth (e.g., 20 MHz) of the initial UL BWP configured for the UE), the frequency hops for the inter-slot frequency hopping would typically be contained within the maximum bandwidth (e.g., the sub-band of the initial UL BWP) allocated to the UE. However, such frequency hopping within one sub-band allocated to the UE may not provide an adequate frequency diversity gain due to the limited bandwidth of the sub-band. The aspects described herein may enable a UE, such as an eRedCap UE, to transmit a UL message (e.g., a message 3 (Msg3)) and one or more repetitions of the UL message across multiple sub-bands within an initial UL BWP of the UE.

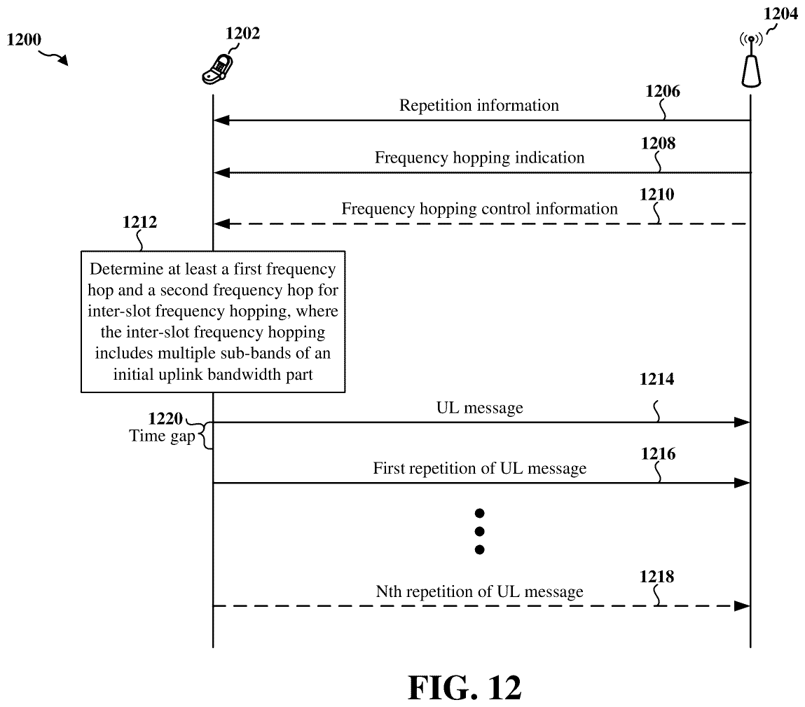

FIG. 12 is a signal flow diagram 1200 in accordance with various aspects of the disclosure. FIG. 12 includes a UE 1202 and a network node 1204. In some examples, the UE 1202 may be an eRedCap UE. In some examples, the network node 1204 may be a base station.

The UE 1202 may receive repetition information 1206 enabling one or more repetitions of an uplink message transmission associated with a network access procedure (e.g., the four-step RACH procedure 510). In some examples, the uplink message may be the Msg 3 516.

In some aspects, the maximum bandwidth allocated to the UE 1202 may be less than a bandwidth of an initial UL BWP of the UE 1202. For example, with reference to FIG. 10, the UE 1202 may be configured with the initial UL BWP 802 having a bandwidth 804, but the maximum bandwidth allocated to the UE 1202 may be the bandwidth 1002 (e.g., the sub-band_0 950).

The UE 1202 may receive a frequency hopping indication 1208 for the one or more repetitions of the uplink message transmission. In some examples, the frequency hopping indication 1208 includes a frequency hopping flag that enables or disables frequency hopping using multiple sub-bands of the initial UL BWP of the UE 1202. In some examples, the frequency hopping flag may be included in a UL grant of an RAR message or in DCI (e.g., DCI format 0_0) with CRC scrambled by TC-RNTI.

The UE 1202 may receive frequency hopping control information 1210. In some examples, the frequency hopping control information 1210 indicates at least one of a number of the multiple sub-bands to be used for the inter-slot frequency hopping or a frequency hopping pattern for the inter-slot frequency hopping. For example, the number of the multiple sub-bands to be used for the inter-slot frequency hopping may be two. In some aspects, the number of the multiple sub-bands to be used for the inter-slot frequency hopping may be preconfigured at the UE 1202.

In some aspects, the number of multiple sub-bands to be used for the inter-slot frequency hopping in the frequency hopping control information 1210 may be based on the capability of the UE 1202. The UE 1202 may indicate the capability of the UE 1202 in message 1 (Msg) on the PRACH.

At 1212, the UE 1202 determines at least a first frequency hop and a second frequency hop for inter-slot frequency hopping, where the inter-slot frequency hopping includes multiple sub-bands of an initial UL BWP. In some aspects, the first frequency hop may include a first set of sub-bands of the multiple sub-bands and the second frequency hop includes a second set of sub-bands of the multiple sub-bands, where the first set of sub-bands are nonoverlapping with the second set of sub-bands. Each of the different slots may be associated with either the first frequency hop or the second frequency hop based on a frequency hopping pattern.

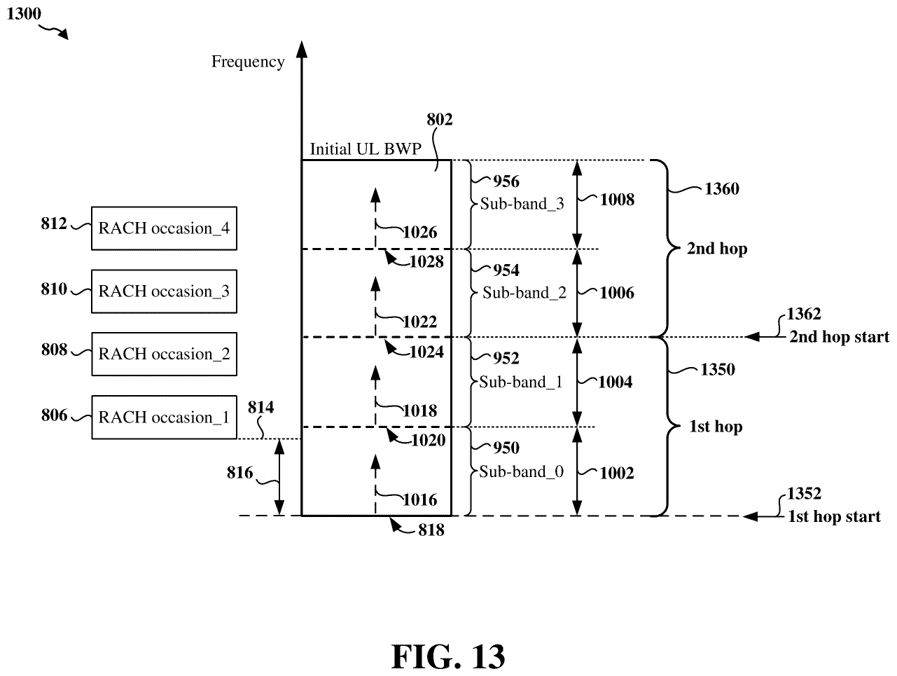

FIG. 13 is a diagram 1300 illustrating an example of a first frequency hop and a second frequency hop of an initial UL BWP for inter-slot frequency hopping, where the inter-slot frequency hopping includes multiple sub-bands of an initial UL BWP. In one example, with reference to FIG. 13, the UE 1202 may determine two frequency hops (also herein referred to as hops) including a first hop 1350 and a second hop 1360. As shown in FIG. 13, the first hop 1350 includes sub-band_0 950 and sub-band_1 952 and the second hop 1360 includes sub-band_2 954 and sub-band_3 956. The first hop 1350 may start at the starting RB 818 of sub-band_0 950 (e.g., indicated as the first hop start 1352 in FIG. 13) and the second hop 1360 may start at the first RB 1024 of sub-band_2 954 (e.g., indicated as the second hop start 1362 in FIG. 13).

The UE 1202 may transmit an uplink message, such as the UL message 1214, and one or more repetitions of the uplink message, such as the first repetition 1216 of the UL message 1214 and any additional repetitions (e.g., the Nth repetition 1218) of the UL message 1214, in different slots using inter-slot frequency hopping based at least on the repetition information 1206 and the frequency hopping indication 1208. The inter-slot frequency hopping may include multiple sub-bands of the initial UL BWP. In other words, the UE 1202 may perform the inter-slot frequency hopping using multiple sub-bands of the initial UL BWP 802. The UE 1202 may use a single sub-band of the multiple sub-bands in each of the different slots.

The initial hop for purposes of inter-slot frequency hopping may depend on a sub-band selected by the UE 1202 for a message transmission (e.g., a PRACH transmission) or a message reception (e.g., reception of message 2 (Msg2) from the network node 1204) using a time division duplex (TDD) scheme. For example, if the selected sub-band fully overlaps with the second hop 1360 (e.g., if the selected sub-band is sub-band_2 954 or sub-band_3 956), the initial hop is the second hop 1360. If the selected sub-band fully overlaps with the first hop 1350 (e.g., if the selected sub-band is sub-band_0 950 or sub-band_1 952), the initial hop is the first hop 1350.

In the example where the UE 1202 determines two hops (e.g., including a first hop 1350 and a second hop 1360) and where one of the two hops is the initial hop, the next hop immediately after the initial hop may include a sub-band that is fully overlapping with the other hop of the two hops. For example, if the selected sub-band for the initial hop corresponds to the second hop 1360 (e.g., if the selected sub-band is sub-band_2 954 or sub-band_3 956), the next hop immediately after the initial hop corresponds to the first hop 1350.

For example, if the UE 1202 selects sub-band_3 956 to transmit message 1 (Msg1) of an initial access procedure on the PRACH, the initial hop may be the second hop 1360 (e.g., since the selected sub-band_3 956 fully overlaps the second hop 1360). The UE 1202 may use sub-band_3 956 (e.g., the second hop 1360) to transmit a UL message 1214 (e.g., message 3 (Msg3) of an initial access procedure). The UE 1202 may use one of the sub-bands of the first hop 1350 to transmit a first repetition 1216 of the UL message 1214.

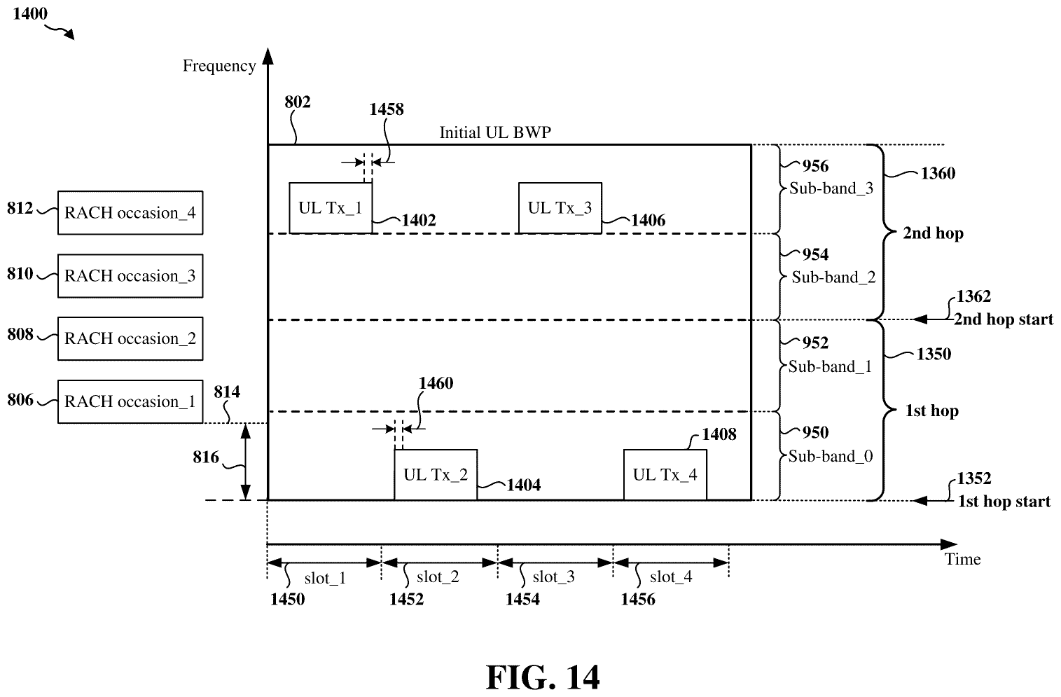

In a first example, if there are multiple sub-bands in the other hop and the frequency hopping pattern indicates to use the lowest sub-band of the other hop (e.g., the first hop 1350), the UE 1202 may use the sub-band_0 950 of the first hop 1350 to transmit a first repetition of the UL message 1214 (e.g., message 3 (Msg3)). The UE 1202 may use the selected sub-band_3 956 in the second hop 1360 to transmit a second repetition of the UL message (e.g., message 3 (Msg3)). The UE 1202 may use the sub-band_0 950 of the first hop 1350 to transmit a third repetition of the UL message 1214 (e.g., message 3 (Msg3)). Therefore, the UE 1202 may alternate between the sub-band_0 950 of the first hop 1350 and sub-band_3 956 of the second hop 1360 to transmit each repetition of the UL message. This is described in detail with reference to FIG. 14.

FIG. 14 is a diagram 1400 illustrating inter-slot frequency hopping between multiple sub-bands of an initial UL BWP in accordance with various aspects of the disclosure. For example, in the first slot (slot_1) 1450 shown in FIG. 14, the UE 1202 may transmit the UL message 1214 in the first UL transmission (UL Tx_1) 1402 using the sub-band_3 956 of the second hop 1360. In the second slot (slot_2) 1452, the UE 1202 may transmit a first repetition 1216 of the UL message 1214 in the second UL transmission (UL Tx_2) 1404 using sub-band_0 950 of the first hop 1350. In the third slot (slot_3) 1454, the UE 1202 may transmit a second repetition of the UL message 1214 in the third UL transmission (UL Tx_3) 1406 using sub-band_3 956 of the second hop 1360. In the fourth slot (slot_4) 1456, the UE 1202 may transmit a third repetition of the UL message 1214 in the fourth UL transmission (UL Tx_4) 1408 using sub-band_0 950 of the first hop 1350.

In a second example, if there are multiple sub-bands in the other hop and the frequency hopping pattern indicates to use the highest sub-band of the other hop (e.g., the first hop 1350), the UE 1202 may use the sub-band_1 952 of the first hop 1350 to transmit a first repetition of the UL message 1214 (e.g., message 3 (Msg3)). The UE 1202 may use the selected sub-band_3 956 in the second hop 1360 to transmit a second repetition of the UL message (e.g., message 3 (Msg3)). The UE 1202 may use the sub-band_1 952 of the first hop 1350 to transmit a third repetition of the UL message 1214 (e.g., message 3 (Msg3)). Therefore, the UE 1202 may alternate between sub-band_1 952 of the first hop 1350 and sub-band_3 956 of the second hop 1360 to transmit each repetition of the UL message.

In some aspects, the frequency hopping pattern for the transmission of the UL message and the one or more repetitions of the UL message indicates the first frequency hop or the second frequency hop for each of the different slots based on an index value of each of the different slots. In some aspects, if there are multiple sub-bands in a hop, the UE 1202 may select the lowest sub-band or the highest sub-band in the hop for transmission of a repetition of the UL message.

In some aspects of the disclosure, the UE 1202 may use an initial set of resources (e.g., a first RB) of a sub-band to transmit an uplink message (e.g., UL message 1214) or one or more repetitions of the uplink message (e.g., the first repetition 1216 of the UL message 1214). The start of each frequency hop (e.g., the first hop 1350, the second hop 1360) may depend on the first RB of the sub-band the UE 1202 uses for transmission of a UL message or a repetition of the UL message. Therefore, the UE 1202 may not need to apply the hop offset determination described with reference to equation (1) and equation (2). Therefore, if the UE 1202 selects a sub-band for transmission of a UL message or a repetition of the UL message, the UE 1202 may start the transmission from the first RB of the sub-band.

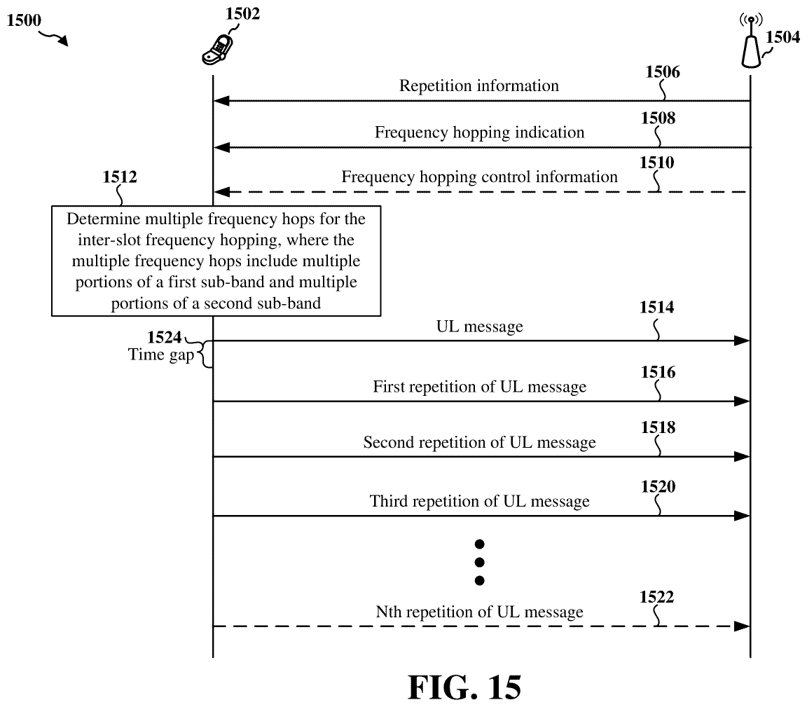

FIG. 15 is a signal flow diagram 1500 in accordance with various aspects of the disclosure. FIG. 15 includes a UE 1502 and a network node 1504. In some examples, the UE 1502 may be an eRedCap UE. In some examples, the network node 1504 may be a base station.

The UE 1502 may receive repetition information 1506 enabling one or more repetitions of an uplink message transmission associated with a network access procedure (e.g., the four-step RACH procedure 510). In some examples, the uplink message may include a UL message of a RACH procedure, such as the Msg 3 516 described with reference to FIG. 5.

In some aspects, the maximum bandwidth allocated to the UE 1502 may be less than a bandwidth of an initial UL BWP of the UE 1502. For example, with reference to FIG. 13, the UE 1502 may be configured with the initial UL BWP 802 having a bandwidth 804 (as described with reference to FIG. 10), but the maximum bandwidth allocated to the UE 1502 may be the bandwidth 1002 (e.g., the sub-band_0 950).

The UE 1502 may receive a frequency hopping indication for the one or more repetitions of the uplink message transmission. In some examples, the frequency hopping indication includes a frequency hopping flag that enables or disables frequency hopping using multiple sub-bands of the initial UL BWP of the UE 1502. In some examples, the frequency hopping flag may be included in a UL grant of an RAR message or in DCI (e.g., DCI format 0_0) with CRC scrambled by TC-RNTI.

The UE 1502 may receive frequency hopping control information 1510. In some examples, the frequency hopping control information 1510 indicates at least one of a number of the multiple sub-bands to be used for the inter-slot frequency hopping or a frequency hopping pattern for the inter-slot frequency hopping. For example, the number of the multiple sub-bands to be used for the inter-slot frequency hopping may be two. In some aspects, the number of the multiple sub-bands to be used for the inter-slot frequency hopping may be preconfigured at the UE 1502.

In some aspects, the number of multiple sub-bands to be used for the inter-slot frequency hopping in the frequency hopping control information 1510 may be based on the capability of the UE 1502. The UE 1502 may indicate the capability of the UE 1502 in message 1 (Msg) on the PRACH.

At 1512, the UE 1202 determines multiple frequency hops for the inter-slot frequency hopping, where the multiple frequency hops include multiple portions of a first sub-band and multiple portions of a second sub-band. In some aspects, a first frequency hop of the multiple frequency hops may include a first set of sub-bands of the multiple sub-bands and the second frequency hop includes a second set of sub-bands of the multiple sub-bands, where the first set of sub-bands are nonoverlapping with the second set of sub-bands. Each of the different slots may be associated with either the first frequency hop or the second frequency hop based on a frequency hopping pattern.

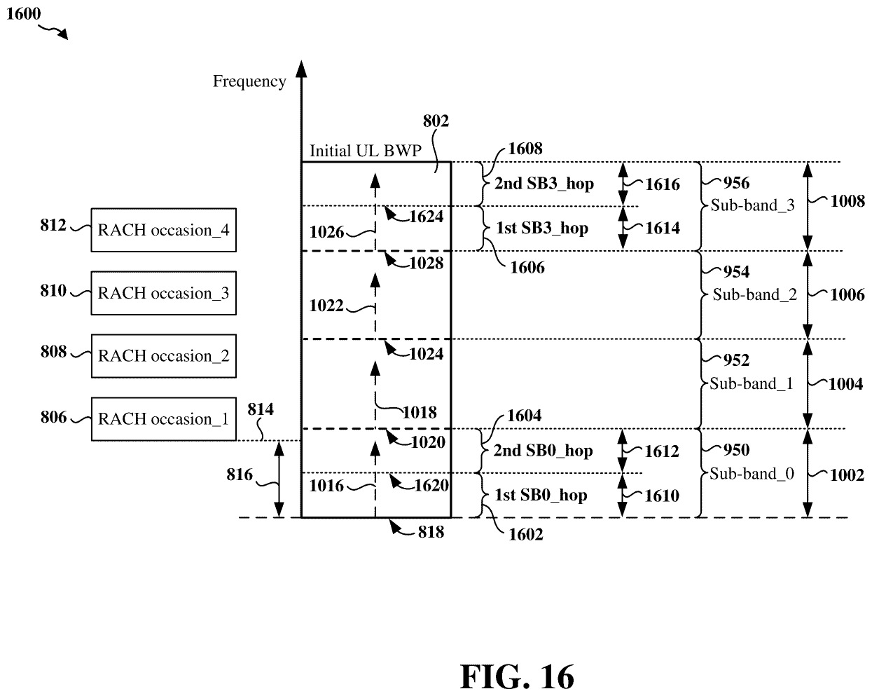

FIG. 16 is a diagram 1600 illustrating the initial UL BWP 802 and the multiple sub-bands of the initial UL BWP 802 including sub-band_0 950, sub-band_1 952, sub-band_2 954, and sub-band_3 956. As shown in the example of FIG. 16, the UE 1502 may determine multiple frequency hops including multiple portions of a first sub-band and multiple portions of a second sub-band. For example, the UE 1502 may determine a first set of hops in sub-band_0 950 including a first hop 1602 (labeled as “1^{st} SB0_hop” in FIG. 16) in sub-band_0 950 and a second hop 1604 (labeled as “2^{nd} SB0_hop” in FIG. 16) in sub-band_0 950. Continuing with this example, the UE 1502 may further determine a second set of hops in sub-band_3 956 including a first hop 1606 (labeled as “1^{st} SB3_hop” in FIG. 16) in sub-band_3 956 and a second hop 1608 (labeled as “2^{nd} SB3_hop” in FIG. 16) in sub-band_3 956.

The first hop 1602 of sub-band_0 950 may have a bandwidth 1610 and may begin at the starting RB 818 of sub-band_0 950. The second hop 1604 of sub-band_0 950 may have a bandwidth 1612 and may start at the jth RB 1620 of sub-band_0 950. The first hop 1606 of sub-band_3 956 may have a bandwidth 1614 and may start at the first RB 1028 of sub-band_3 956. The second hop 1608 of sub-band_3 956 may have a bandwidth 1616 and may start at the jth RB 1624 of sub-band_3 956. For example, j may represent an integer value. In some examples, the UE 1502 may determine the jth RB (e.g., the jth RB 1620 or the jth RB 1624) by using one of the configurations (e.g., [N_{BWP}^{size}/2], [N_{BWP}^{size}/4], −[N_{BWP}^{size}/4]) for determining the frequency offset for the second hop in Table 2 and by using the size of a sub-band (e.g., the size of sub-band_0 950 or sub-band_3 956) as the value for N_{BWP}^{size}, where the size of the sub-band may be the number of RBs in the sub-band.

Referring back to FIG. 15, the UE 1502 may transmit a UL message 1514, and one or more repetitions of the UL message 1514 in different slots using inter-slot frequency hopping based at least on the repetition information 1506 and the frequency hopping indication 1508. Examples of the one or more repetitions of the UL message 1514 may include the first repetition 1516 of the UL message 1514, the second repetition 1518 of the UL message 1514, the third repetition 1520 of the UL message 1514, and the Nth repetition 1522 of the UL message 1514.

The inter-slot frequency hopping may include multiple portions (e.g., the first hop 1602 in sub-band_0 950, the second hop 1604 in sub-band_0 950, the first hop 1606 in sub-band_3 956, and the second hop 1608 in sub-band_3 956) of multiple sub-bands of the initial UL BWP 802. In other words, the UE 1502 may perform the inter-slot frequency hopping using multiple portions of multiple sub-bands of the initial UL BWP 802. The UE 1202 may use a single sub-band of the multiple sub-bands in each of the different slots.

In some aspects, the initial hop for purposes of inter-slot frequency hopping may depend on a portion of a sub-band selected by the UE 1502 for a message transmission (e.g., a PRACH transmission) or a message reception (e.g., reception of message 2 (Msg2) from the network node 1504) using a TDD scheme. In one example, if the selected portion of a sub-band fully overlaps with the first hop 1602 of sub-band_0 950, the initial hop is the first hop 1602. If the selected portion of the sub-band fully overlaps with the second hop 1604 of sub-band_0 950, the initial hop is the second hop 1604. In another example, if the selected portion of a sub-band fully overlaps with the first hop 1606 of sub-band_3 956, the initial hop is the first hop 1606. If the selected portion of the sub-band fully overlaps with the second hop 1608 of sub-band_3 956, the initial hop is the second hop 1608 of sub-band_3 956.

In some aspects where the inter-slot frequency hopping may include multiple portions of multiple sub-bands of the initial UL BWP 802, the order of frequency hopping may be indicated to the UE 1502. For example, a frequency hopping pattern in the frequency hopping control information 1510 may include a sequence of frequency hops the UE 1502 is to apply for the inter-slot frequency hopping. Such a sequence of frequency hops may include frequency hops within a sub-band, frequency hops between different sub-bands, or any combination thereof.

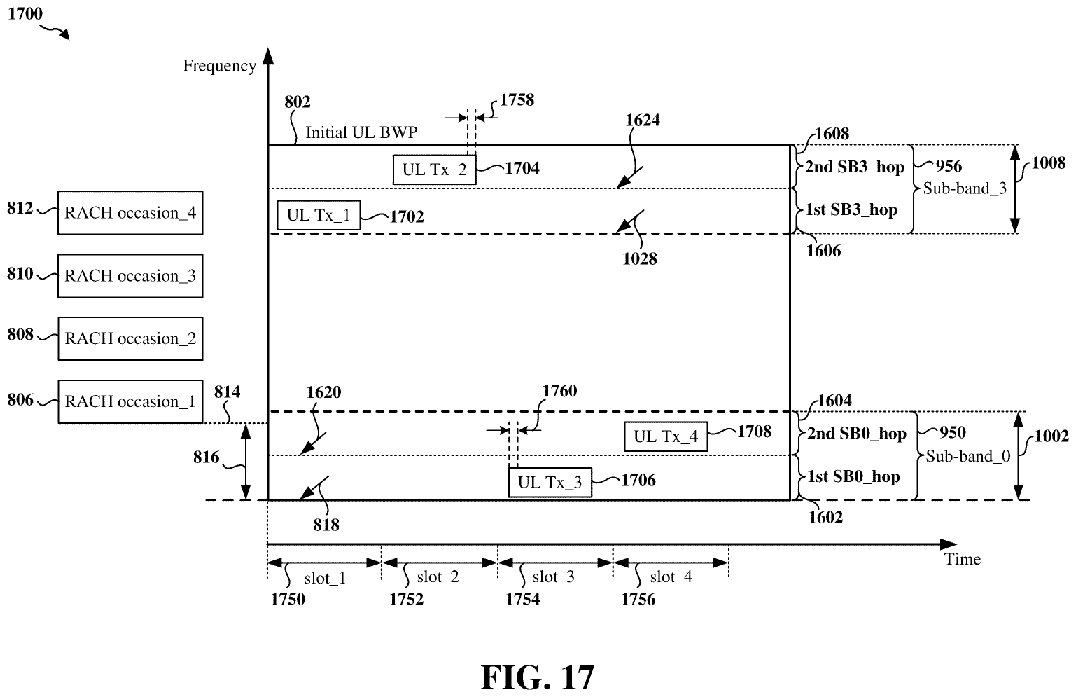

In some examples, the frequency hopping pattern (e.g., in the frequency hopping control information 1510) may indicate to use a first set of frequency hops associated with the first sub-band followed by a second set of frequency hops associated with the second sub-band. The first set of frequency hops and the second set of frequency hops may be included in the plurality of frequency hops. In other words, the frequency hopping pattern may indicate to first perform frequency hopping within a same sub-band of the initial UL BWP 802 and then to perform frequency hopping within a different sub-band of the initial UL BWP 802. This will now be described in detail with reference to FIG. 17.

FIG. 17 is a diagram 1700 illustrating inter-slot frequency hopping within a same sub-band of the initial UL BWP followed by inter-slot frequency hopping within a different sub-band of the initial UL BWP. For example, in the first slot (slot_1) 1750 shown in FIG. 17, the UE 1502 may transmit the UL message 1514 in the first UL transmission (UL Tx_1) 1702 using the first hop 1606 of sub-band_3 956. In the second slot (slot_2) 1752, the UE 1502 may transmit a first repetition 1516 of the UL message 1514 in the second UL transmission (UL Tx_2) 1704 using the second hop 1608 of sub-band_3 956. In the third slot (slot_3) 1754, the UE 1502 may transmit a second repetition 1518 of the UL message 1514 in the third UL transmission (UL Tx_3) 1706 using the first hop 1602 of sub-band_0 950. In the fourth slot (slot_4) 1756, the UE 1502 may transmit a third repetition 1520 of the UL message 1514 in the fourth UL transmission (UL Tx_4) 1708 using the second hop 1604 of sub-band_0 950.

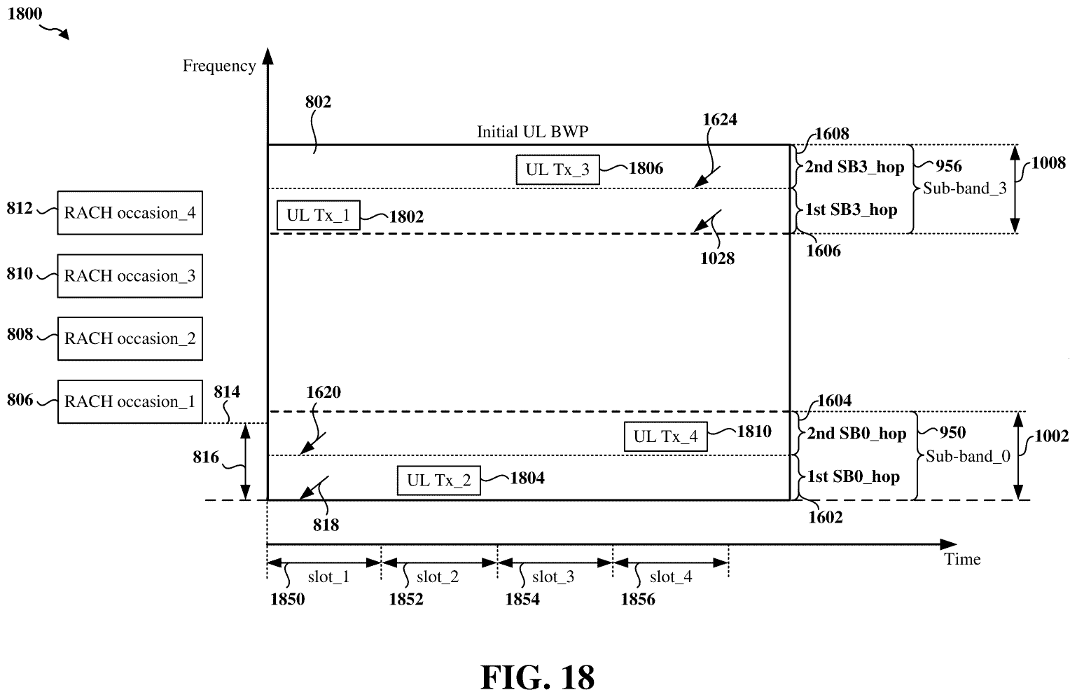

In some examples, the frequency hopping pattern (e.g., in the frequency hopping control information 1510) may indicate to use one of a first set of frequency hops associated with a first sub-band followed by one of a second set of frequency hops associated with a second sub-band. In other words, the frequency hopping pattern may indicate to perform frequency hopping by alternating between sub-bands of the initial UL BWP 802 and the multiple portions of the sub-bands (e.g., the multiple frequency hops within the sub-bands) for successive slots. In these examples, the frequency hopping pattern may interlace frequency hops associated with different sub-bands. This will now be described in detail with reference to FIG. 18.

FIG. 18 is a diagram 1800 illustrating inter-slot frequency hopping by alternating between sub-bands of the initial UL BWP and the multiple portions of the sub-bands for successive slots. For example, in the first slot (slot_1) 1850, the UE 1502 may transmit the UL message 1514 in the first UL transmission (UL Tx_1) 1802 using the first hop 1606 of sub-band_3 956. In the second slot (slot_2) 1852, the UE 1502 may transmit a first repetition 1516 of the UL message 1514 in the second UL transmission (UL Tx_2) 1804 using the first hop 1602 of sub-band_0 950. In the third slot (slot_3) 1854, the UE 1502 may transmit a second repetition 1518 of the UL message 1514 in the third UL transmission (UL Tx_3) 1806 using the second hop 1608 of sub-band_3 956. In the fourth slot (slot_4) 1856, the UE 1502 may transmit a third repetition 1520 of the UL message 1514 in the fourth UL transmission (UL Tx_4) 1810 using the second hop 1604 of sub-band_0 950.

In some aspects of the disclosure, the UE 1202, 1502 may apply at least one time gap (e.g., a time gap 1220, 1458, 1460, 1524, 1758, 1760) between a transmission of an uplink message and the one or more repetitions of the uplink message to enable switching between the multiple sub-bands of the initial UL BWP 802 of the UE 1202, 1502 during inter-slot frequency hopping. In some examples, the time gap provides sufficient time for the UE 1202, 1502 to perform hardware tuning to switch between one sub-band to another sub-band for purposes of transmitting a UL message.

The time gap may be applied in a current hop and/or a next hop. The time gap may also be applied between repetitions of the uplink message.

For example, with reference to FIG. 17, if the UE 1502 transmits the first repetition 1516 of the UL message 1514 in the second UL transmission (UL Tx_2) 1704 and transmits the second repetition 1518 of the UL message 1514 in the third UL transmission (UL Tx_3) 1706 as described herein, the UE 1502 may apply a first time gap 1758 and/or a second time gap 1760 between the transmission of the first repetition 1516 of the UL message 1514 and the second repetition 1518 of the UL message 1514.

In some examples, the value of first time gap 1758 and/or the second time gap 1760 may be specified in a wireless communications standard (e.g., a 3GPP standard) implemented at the UE 1202, 1502. For example, the value of the first time gap 1758 and/or the second time gap 1760 may be one symbol. In other examples, the value of the first time gap 1758 and/or the second time gap 1760 may be indicated to the UE 1202, 1502 via signaling (e.g., in a SIB, such as SIB1).

In some scenarios, the time gap applied at the UE 1202, 1502 may overlap one or more portions of a UL message transmission. In these scenarios, the UE 1202, 1502 may puncture the symbols of the UL message transmission overlapping with the time gap or may apply rate matching to the UL message transmission.

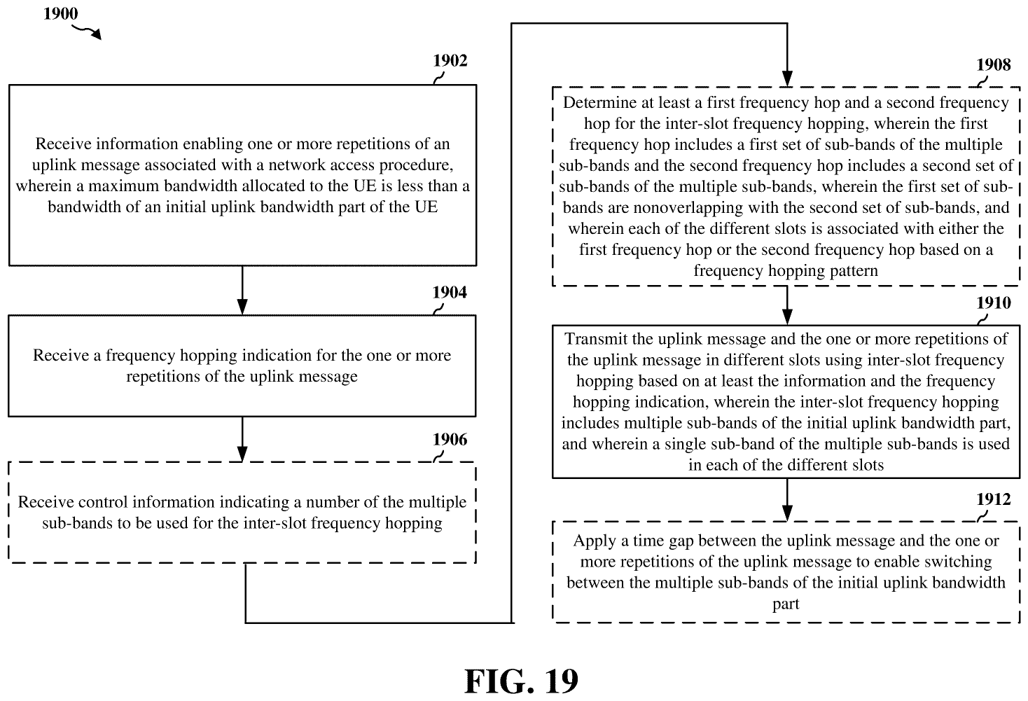

FIG. 19 is a flowchart 1900 of a method of wireless communication. The method may be performed by a UE (e.g., the UE 104, 1202, 1502; the apparatus 2102/2102′; the processing system 2214, which may include the memory 360 and which may be the entire UE or a component of the UE, such as the TX processor 368, the RX processor 356, and/or the controller/processor 359). It should be understood that blocks indicated with dashed lines in FIG. 19 represent optional blocks.

At 1902, the UE receives information enabling one or more repetitions of an uplink message associated with a network access procedure. A maximum bandwidth allocated to the UE is less than a bandwidth of an initial uplink bandwidth part of the UE. For example, the UE 1202 may receive repetition information 1206 enabling one or more repetitions of an uplink message transmission associated with a network access procedure (e.g., the four-step RACH procedure 510). In some examples, the uplink message may be the Msg 3 516. For example, with reference to FIG. 10, the UE 1202 may be configured with the initial UL BWP 802 having a bandwidth 804, but the maximum bandwidth allocated to the UE 1202 may be the bandwidth 1002 (e.g., the sub-band_0 950).

At 1904, the UE receives a frequency hopping indication for the one or more repetitions of the uplink message. For example, the UE 1202 may receive the frequency hopping indication 1208 for the one or more repetitions of the uplink message transmission. In some examples, the frequency hopping indication 1208 includes a frequency hopping flag that enables or disables frequency hopping using multiple sub-bands of the initial UL BWP of the UE 1202.

At 1906, the UE receives control information indicating a number of the multiple sub-bands to be used for the inter-slot frequency hopping. In some examples, the control information may be the frequency hopping control information 1210 described with reference to FIG. 12. In one example, the frequency hopping control information 1210 indicates that the number of the multiple sub-bands to be used for the inter-slot frequency hopping is two. In some aspects, the number of the multiple sub-bands to be used for the inter-slot frequency hopping may be preconfigured at the UE 1202.

At 1908, the UE determines at least a first frequency hop and a second frequency hop for the inter-slot frequency hopping. The first frequency hop includes a first set of sub-bands of the multiple sub-bands and the second frequency hop includes a second set of sub-bands of the multiple sub-bands. The first set of sub-bands are nonoverlapping with the second set of sub-bands. Each of the different slots is associated with either the first frequency hop or the second frequency hop based on a frequency hopping pattern.

In one example, with reference to FIG. 12 at 1212 and FIG. 13, the UE 1202 may determine two frequency hops including a first hop 1350 and a second hop 1360. As shown in FIG. 13, the first hop 1350 includes sub-band_0 950 and sub-band_1 952 and the second hop 1360 includes sub-band_2 954 and sub-band_3 956. For example, with reference to FIG. 14, slot_1 1450 and slot_3 1454 may be associated with the second hop 1360, and slot_2 1452 and slot_4 1456 may be associated with the first hop 1350.

In some examples, and as shown in FIG. 14, the frequency hopping pattern alternates between the first frequency hop and the second frequency hop for successive slots of the different slots. In some examples, the frequency hopping pattern indicates the first frequency hop or the second frequency hop for each of the different slots based on an index value of each of the different slots. In some examples, the frequency hopping pattern indicates to use a lowest sub-band in the first set of sub-bands of the first frequency hop or the second set of sub-bands of the second frequency hop. In some examples, the frequency hopping pattern indicates to use a highest sub-band in the first set of sub-bands of the first frequency hop or the second set of sub-bands of the second frequency hop.

At 1910, the UE transmits the uplink message and the one or more repetitions of the uplink message in different slots using inter-slot frequency hopping based on at least the information (e.g., the information enabling one or more repetitions of an uplink message associated with a network access procedure) and the frequency hopping indication. The inter-slot frequency hopping includes multiple sub-bands of the initial uplink bandwidth part. A single sub-band of the multiple sub-bands is used in each of the different slots.

For example, with reference to FIG. 14, if the UE 1202 receives the repetition information 1206 and the frequency hopping indication 1208 (e.g., a frequency hopping flag set to enable frequency hopping), the UE 1202 may transmit the UL message 1214 in the first UL transmission (UL Tx_1) 1402 using the sub-band_3 956 of the second hop 1360. In the second slot (slot_2) 1452, the UE 1202 may transmit a first repetition 1216 of the UL message 1214 in the second UL transmission (UL Tx_2) 1404 using sub-band_0 950 of the first hop 1350. In the third slot (slot_3) 1454, the UE 1202 may transmit a second repetition of the UL message 1214 in the third UL transmission (UL Tx_3) 1406 using sub-band_3 956 of the second hop 1360. In the fourth slot (slot_4) 1456, the UE 1202 may transmit a third repetition of the UL message 1214 in the fourth UL transmission (UL Tx_4) 1408 using sub-band_0 950 of the first hop 1350.

At 1912, the UE applies a time gap between the uplink message and the one or more repetitions of the uplink message to enable switching between the multiple sub-bands of the initial uplink bandwidth part. For example, the UE may apply a time gap by not transmitting on the uplink for a certain duration (e.g., one OFDM symbol).

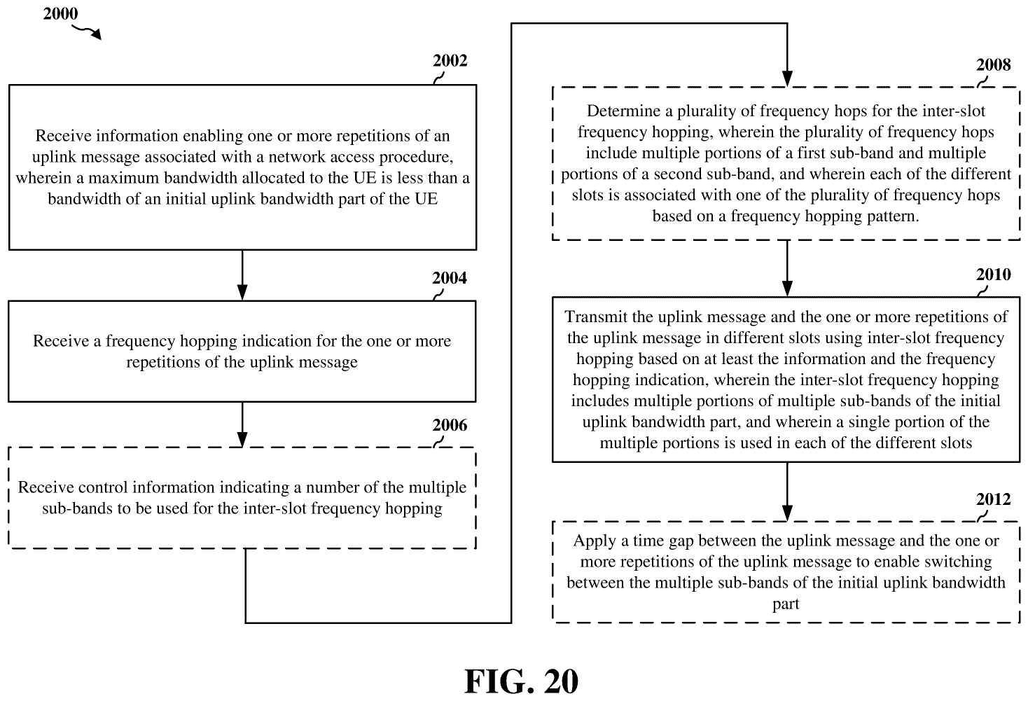

FIG. 20 is a flowchart 2000 of a method of wireless communication. The method may be performed by a UE (e.g., the UE 104, 1202, 1502; the apparatus 2102/2102′; the processing system 2214, which may include the memory 360 and which may be the entire UE or a component of the UE, such as the TX processor 368, the RX processor 356, and/or the controller/processor 359). It should be understood that blocks indicated with dashed lines in FIG. 20 represent optional blocks.

At 2002, the UE receives information enabling one or more repetitions of an uplink message associated with a network access procedure. A maximum bandwidth allocated to the UE is less than a bandwidth of an initial uplink bandwidth part of the UE.

For example, the UE 1502 may receive repetition information 1506 enabling one or more repetitions of an uplink message transmission associated with a network access procedure (e.g., the four-step RACH procedure 510). In some examples, the uplink message may include a UL message of a RACH procedure, such as the Msg 3 516 described with reference to FIG. 5. For example, with reference to FIG. 13, the UE 1502 may be configured with the initial UL BWP 802 having a bandwidth 804 (as described with reference to FIG. 10), but the maximum bandwidth allocated to the UE 1502 may be the bandwidth 1002 (e.g., the sub-band_0 950).

At 2004, the UE receives a frequency hopping indication for the one or more repetitions of the uplink message. For example, the UE 1502 may receive a frequency hopping indication 1508 for the one or more repetitions of the uplink message transmission. In some examples, the frequency hopping indication 1508 includes a frequency hopping flag that enables or disables frequency hopping using multiple sub-bands of the initial UL BWP of the UE 1502.

At 2006, the UE receives control information indicating a number of the multiple sub-bands to be used for the inter-slot frequency hopping. In some examples, the control information may be the frequency hopping control information 1510 described with reference to FIG. 15. In some examples, the frequency hopping control information 1510 indicates at least one of a number of the multiple sub-bands to be used for the inter-slot frequency hopping or a frequency hopping pattern for the inter-slot frequency hopping. For example, the number of the multiple sub-bands to be used for the inter-slot frequency hopping may be two.

At 2008, the UE determines a plurality of frequency hops for the inter-slot frequency hopping, wherein the plurality of frequency hops include multiple portions of a first sub-band and multiple portions of a second sub-band, and wherein each of the different slots is associated with one of the plurality of frequency hops based on a frequency hopping pattern.

As shown in the example of FIG. 16, the UE 1502 may determine multiple frequency hops including multiple portions of a first sub-band and multiple portions of a second sub-band. For example, the UE 1502 may determine the first set of hops in sub-band_0 950 including the first hop 1602 (labeled as “1^{st} SB0_hop” in FIG. 16) in sub-band_0 950 and the second hop 1604 (labeled as “2^{nd} SB0_hop” in FIG. 16) in sub-band_0 950. Continuing with this example, the UE 1502 may further determine the second set of hops in sub-band_3 956 including the first hop 1606 (labeled as “1^{st} SB3_hop” in FIG. 16) in sub-band_3 956 and the second hop 1608 (labeled as “2^{nd} SB3_hop” in FIG. 16) in sub-band_3 956.

At 2010, the UE transmits the uplink message and the one or more repetitions of the uplink message in different slots using inter-slot frequency hopping based on at least the information (e.g., the information enabling one or more repetitions of an uplink message associated with a network access procedure) and the frequency hopping indication. The inter-slot frequency hopping includes multiple portions of multiple sub-bands of the initial uplink bandwidth part. A single portion of the multiple portions is used in each of the different slots.

In one example, in the first slot (slot_1) 1750 shown in FIG. 17, the UE 1502 may transmit the UL message 1514 in the first UL transmission (UL Tx_1) 1702 using the first hop 1606 of sub-band_3 956. In the second slot (slot_2) 1752, the UE 1502 may transmit a first repetition 1516 of the UL message 1514 in the second UL transmission (UL Tx_2) 1704 using the second hop 1608 of sub-band_3 956. In the third slot (slot_3) 1754, the UE 1502 may transmit a second repetition 1518 of the UL message 1514 in the third UL transmission (UL Tx_3) 1706 using the first hop 1602 of sub-band_0 950. In the fourth slot (slot_4) 1756, the UE 1502 may transmit a third repetition 1520 of the UL message 1514 in the fourth UL transmission (UL Tx_4) 1708 using the second hop 1604 of sub-band_0 950.

In another example, in the first slot (slot_1) 1850 shown in FIG. 18, the UE 1502 may transmit the UL message 1514 in the first UL transmission (UL Tx_1) 1802 using the first hop 1606 of sub-band_3 956. In the second slot (slot_2) 1852, the UE 1502 may transmit a first repetition 1516 of the UL message 1514 in the second UL transmission (UL Tx_2) 1804 using the first hop 1602 of sub-band_0 950. In the third slot (slot_3) 1854, the UE 1502 may transmit a second repetition 1518 of the UL message 1514 in the third UL transmission (UL Tx_3) 1806 using the second hop 1608 of sub-band_3 956. In the fourth slot (slot_4) 1856, the UE 1502 may transmit a third repetition 1520 of the UL message 1514 in the fourth UL transmission (UL Tx_4) 1810 using the second hop 1604 of sub-band_0 950.

At 2012, the UE applies a time gap between the uplink message and the one or more repetitions of the uplink message to enable switching between the multiple sub-bands of the initial uplink bandwidth part. For example, the UE may apply a time gap by not transmitting on the uplink for a certain duration (e.g., one OFDM symbol).

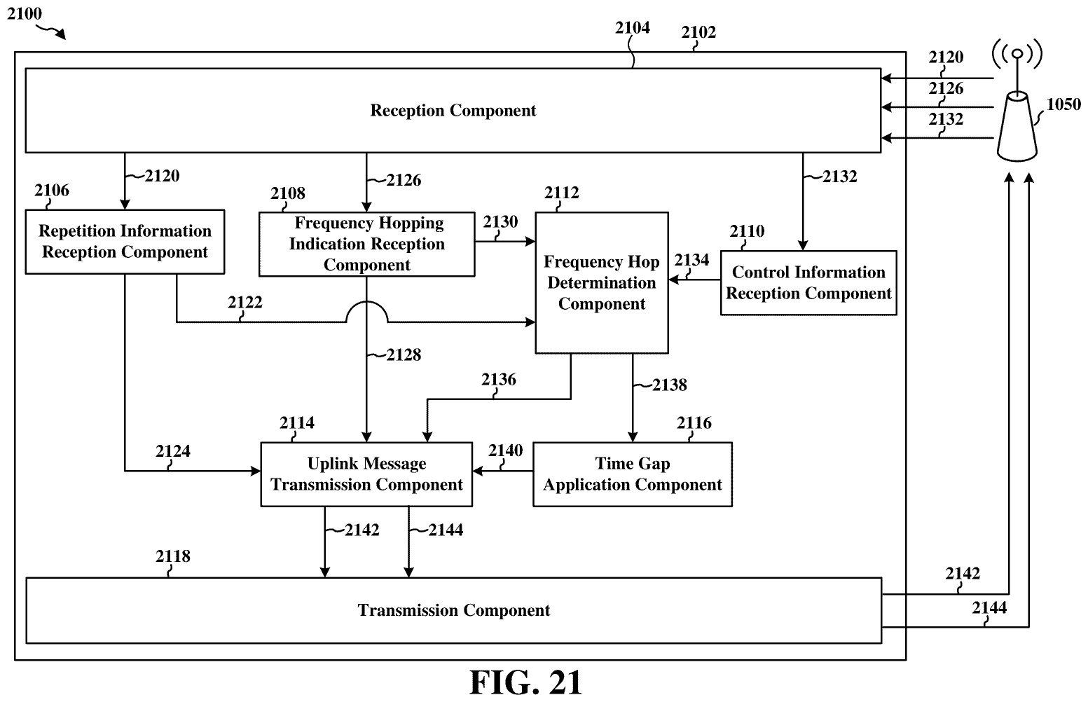

FIG. 21 is a conceptual data flow diagram 2100 illustrating the data flow between different means/components in an example apparatus 2102. The apparatus may be a UE.

The apparatus includes a reception component 2104 that receives downlink signals from the network node 1050. The apparatus further includes a repetition information reception component 2106 that receives (e.g., via the reception component 2104) information enabling one or more repetitions of a UL message associated with a network access procedure. For example, the information enabling one or more repetitions of a UL message associated with a network access procedure may be repetition information 2120 received via the reception component 2104.

The apparatus further includes a frequency hopping indication reception component 2108 that receives (e.g., via the reception component 2104) a frequency hopping indication 2126 for the one or more repetitions of the UL message.

The apparatus further includes a control information reception component 2110 that receives (e.g., via the reception component 2104) control information 2132 indicating a number of the multiple sub-bands to be used for the inter-slot frequency hopping.

The apparatus further includes a frequency hop determination component 2112. The frequency hop determination component 2112 determines at least a first frequency hop and a second frequency hop for the inter-slot frequency hopping, where the first frequency hop includes a first set of sub-bands of the multiple sub-bands and the second frequency hop includes a second set of sub-bands of the multiple sub-bands. The first set of sub-bands are nonoverlapping with the second set of sub-bands. Each of the different slots is associated with either the first frequency hop or the second frequency hop based on a frequency hopping pattern.

The frequency hop determination component 2112 further determines a plurality of frequency hops for the inter-slot frequency hopping, where the plurality of frequency hops include multiple portions of a first sub-band and multiple portions of a second sub-band. Each of the different slots is associated with one of the plurality of frequency hops based on a frequency hopping pattern.

The frequency hop determination component 2112 receives the repetition information 2120 from the repetition information reception component 2106 via a signal 2122. The frequency hop determination component 2112 further receives the frequency hopping indication 2126 from the frequency hopping indication reception component 2108 via a signal 2130. The frequency hop determination component 2112 further receives the control information 2132 from the control information reception component 2110 via a signal 2134.

The apparatus includes an uplink message transmission component 2114 that transmits the UL message (e.g., the UL message 2142) and the one or more repetitions of the UL message (e.g., the repetition 2144 of the UL message 2142) in different slots using inter-slot frequency hopping based on at least the information enabling one or more repetitions of the UL message associated with the network access procedure and the frequency hopping indication. In some aspects, the inter-slot frequency hopping includes multiple sub-bands of the initial uplink bandwidth part, and a single sub-band of the multiple sub-bands is used in each of the different slots. In other aspects, the inter-slot frequency hopping includes multiple portions of multiple sub-bands of the initial uplink bandwidth part, and a single portion of the multiple portions is used in each of the different slots.

The uplink message transmission component 2114 receives the repetition information 2120 from the repetition information reception component 2106 via a signal 2124. The uplink message transmission component 2114 further receives the frequency hopping indication 2126 from the frequency hopping indication reception component 2108 via a signal 2128. The uplink message transmission component 2114 further receives one or more frequency hops for the inter-slot frequency hopping from the frequency hop determination component 2112 via a signal 2136.

The uplink message transmission component 2114 may puncture one or more portions of the UL message or of the one or more repetitions of the UL message overlapping with a time gap. The uplink message transmission component 2114 may rate match the UL message or the one or more repetitions of the UL message when the time gap overlaps the UL message or the one or more repetitions of the UL message.

The apparatus includes a time gap application component 2116 that applies a time gap between the UL message and the one or more repetitions of the UL message to enable switching between the multiple sub-bands of the initial uplink bandwidth part. The time gap application component 2116 may receive the one or more frequency hops for the inter-slot frequency hopping from the frequency hop determination component 2112 via a signal 2138. The time gap application component 2116 may indicate a time gap to the uplink message transmission component 2114 via a signal 2140.

The apparatus includes a transmission component 2118 that transmits uplink signals. For example, the transmission component 2118 may transmit the UL message 2142 and the repetition 2144 of the UL message 2142.

The apparatus may include additional components that perform each of the blocks of the algorithm in the aforementioned flowcharts of FIGS. 19 and 20. As such, each block in the aforementioned flowcharts of FIGS. 19 and 20 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

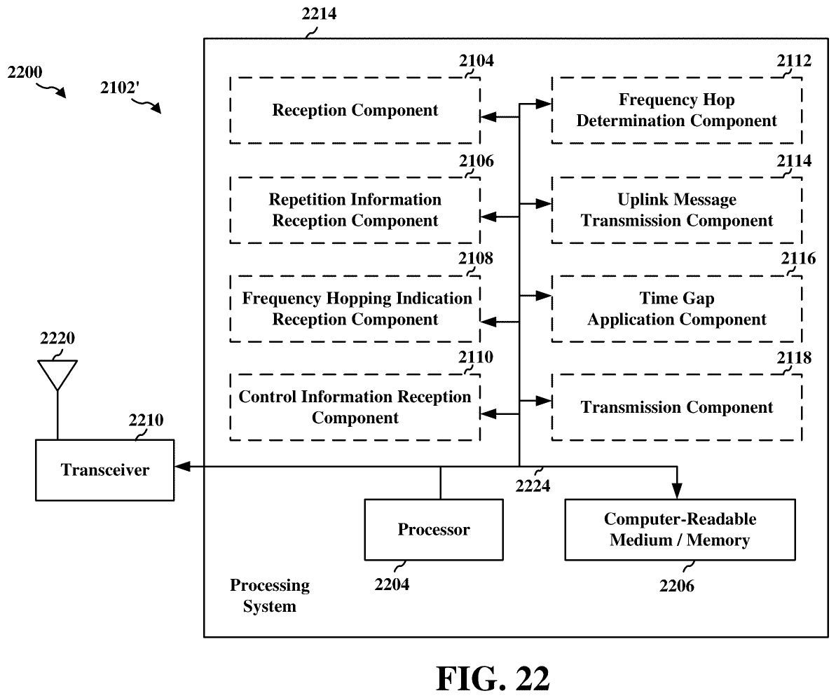

FIG. 22 is a diagram 2200 illustrating an example of a hardware implementation for an apparatus 2102′ employing a processing system 2214. The processing system 2214 may be implemented with a bus architecture, represented generally by the bus 2224. The bus 2224 may include any number of interconnecting buses and bridges depending on the specific application of the processing system 2214 and the overall design constraints. The bus 2224 links together various circuits including one or more processors and/or hardware components, represented by the processor 2204, the components 2104, 2106, 2108, 2110, 2112, 2114, 2116, 2118 and the computer-readable medium/memory 2206. The bus 2224 may also link various other circuits such as timing sources, peripherals, voltage regulators, and power management circuits, which are well known in the art, and therefore, will not be described any further.

The processing system 2214 may be coupled to a transceiver 2210. The transceiver 2210 is coupled to one or more antennas 2220. The transceiver 2210 provides a means for communicating with various other apparatus over a transmission medium. The transceiver 2210 receives a signal from the one or more antennas 2220, extracts information from the received signal, and provides the extracted information to the processing system 2214, specifically the reception component 2104. In addition, the transceiver 2210 receives information from the processing system 2214, specifically the transmission component 2118, and based on the received information, generates a signal to be applied to the one or more antennas 2220. The processing system 2214 includes a processor 2204 coupled to a computer-readable medium/memory 2206. The processor 2204 is responsible for general processing, including the execution of software stored on the computer-readable medium/memory 2206. The software, when executed by the processor 2204, causes the processing system 2214 to perform the various functions described supra for any particular apparatus. The computer-readable medium/memory 2206 may also be used for storing data that is manipulated by the processor 2204 when executing software. The processing system 2214 further includes at least one of the components 2104, 2106, 2108, 2110, 2112, 2114, 2116, 2118. The components may be software components running in the processor 2204, resident/stored in the computer readable medium/memory 2206, one or more hardware components coupled to the processor 2204, or some combination thereof. The processing system 2214 may be a component of the UE 350 and may include the memory 360 and/or at least one of the TX processor 368, the RX processor 356, and the controller/processor 359. Alternatively, the processing system 2214 may be the entire UE (e.g., see 350 of FIG. 3).

In one configuration, the apparatus 2102/2102′ for wireless communication includes means for receiving information enabling one or more repetitions of an uplink message associated with a network access procedure, means for receiving a frequency hopping indication for the one or more repetitions of the uplink message, means for transmitting the uplink message and the one or more repetitions of the uplink message in different slots using inter-slot frequency hopping based on at least the information and the frequency hopping indication, where the inter-slot frequency hopping includes multiple sub-bands of the initial uplink bandwidth part, and where a single sub-band of the multiple sub-bands is used in each of the different slots, means for determining at least a first frequency hop and a second frequency hop for the inter-slot frequency hopping, where the first frequency hop includes a first set of sub-bands of the multiple sub-bands and the second frequency hop includes a second set of sub-bands of the multiple sub-bands, where the first set of sub-bands are nonoverlapping with the second set of sub-bands, and where each of the different slots is associated with either the first frequency hop or the second frequency hop based on a frequency hopping pattern, means for receiving control information indicating a number of the multiple sub-bands to be used for the inter-slot frequency hopping, means for applying a time gap between the uplink message and the one or more repetitions of the uplink message to enable switching between the multiple sub-bands of the initial uplink bandwidth part, means for transmitting the uplink message and the one or more repetitions of the uplink message in different slots using inter-slot frequency hopping based on at least the information and the frequency hopping indication, wherein the inter-slot frequency hopping includes multiple portions of multiple sub-bands of the initial uplink bandwidth part, and wherein a single portion of the multiple portions is used in each of the different slots, means for determining a plurality of frequency hops for the inter-slot frequency hopping, where the plurality of frequency hops include multiple portions of a first sub-band and multiple portions of a second sub-band, and where each of the different slots is associated with one of the plurality of frequency hops based on a frequency hopping pattern.

The aforementioned means may be one or more of the aforementioned components of the apparatus 2102 and/or the processing system 2214 of the apparatus 2102′ configured to perform the functions recited by the aforementioned means. As described supra, the processing system 2214 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Therefore, the aspects described herein may allow a UE with limited bandwidth (e.g., an eRedCap UE) to increase its frequency diversity gain when using inter-slot frequency hopping to transmit repetitions of a UL message (e.g., message 3 (Msg3) of a four-step RACH procedure). For example, a UE having a maximum bandwidth that is less than or equal to a single sub-band of an initial UL BWP of the UE may transmit the UL message and one or more repetitions of the UL message across multiple sub-bands within the initial UL BWP. The use of the multiple sub-bands for the inter-slot frequency hopping may allow the UE to successfully transmit the UL message with a lower number of repetitions as compared to scenarios where only a single sub-band of the initial UL BWP of the UE is used for the inter-slot frequency hopping. The lower number of repetitions may allow the UE to complete the initial access procedure more quickly, thereby improving the performance of the UE.

The following provides an overview of aspects of the present disclosure:

Aspect 1: An apparatus for wireless communication, comprising: a memory; and at least one processor coupled to the memory and configured to: receive information enabling one or more repetitions of an uplink message associated with a network access procedure, wherein a maximum bandwidth allocated to the apparatus is less than a bandwidth of an initial uplink bandwidth part of the apparatus; receive a frequency hopping indication for the one or more repetitions of the uplink message; and transmit the uplink message and the one or more repetitions of the uplink message in different slots using inter-slot frequency hopping based on at least the information and the frequency hopping indication, wherein the inter-slot frequency hopping includes multiple sub-bands of the initial uplink bandwidth part, and wherein a single sub-band of the multiple sub-bands is used in each of the different slots.

Aspect 2: The apparatus of aspect 1, wherein the frequency hopping indication includes a frequency hopping flag that enables or disables frequency hopping using the multiple sub-bands of the initial uplink bandwidth part.

Aspect 3: The apparatus of aspect 1 or 2, wherein the at least one processor is further configured to: determine at least a first frequency hop and a second frequency hop for the inter-slot frequency hopping, wherein the first frequency hop includes a first set of sub-bands of the multiple sub-bands and the second frequency hop includes a second set of sub-bands of the multiple sub-bands, wherein the first set of sub-bands are nonoverlapping with the second set of sub-bands, and wherein each of the different slots is associated with either the first frequency hop or the second frequency hop based on a frequency hopping pattern.

Aspect 4: The apparatus of any of aspects 1 through 3, wherein the frequency hopping pattern alternates between the first frequency hop and the second frequency hop for successive slots of the different slots.

Aspect 5: The apparatus of any of aspects 1 through 3, wherein the frequency hopping pattern indicates the first frequency hop or the second frequency hop for each of the different slots based on an index value of each of the different slots.

Aspect 6: The apparatus of any of aspects 1 through 5, wherein the frequency hopping pattern indicates to use a lowest sub-band in the first set of sub-bands of the first frequency hop or the second set of sub-bands of the second frequency hop.

Aspect 7: The apparatus of any of aspects 1 through 5, wherein the frequency hopping pattern indicates to use a highest sub-band in the first set of sub-bands of the first frequency hop or the second set of sub-bands of the second frequency hop.

Aspect 8: The apparatus of any of aspects 1 through 7, wherein an initial set of resources of a sub-band of the multiple sub-bands is used for transmission of the uplink message or the one or more repetitions of the uplink message.

Aspect 9: The apparatus of any of aspects 1 through 8, wherein the at least one processor is further configured to: receive control information indicating a number of the multiple sub-bands to be used for the inter-slot frequency hopping.

Aspect 10: The apparatus of any of aspects 1 through 9, wherein the at least one processor is further configured to: apply a time gap between the uplink message and the one or more repetitions of the uplink message to enable switching between the multiple sub-bands of the initial uplink bandwidth part.

Aspect 11: The apparatus of any of aspects 1 through 10, wherein a duration of the time gap is preconfigured at the apparatus or indicated in frequency hopping control information.

Aspect 12: The apparatus of any of aspects 1 through 11, wherein the time gap is applied in a current hop of the inter-slot frequency hopping or a next hop of the inter-slot frequency hopping.

Aspect 13: The apparatus of any of aspects 1 through 12, wherein the at least one apparatus configured to apply the time gap between the uplink message and the one or more repetitions of the uplink message is further configured to: puncture one or more portions of the uplink message or of the one or more repetitions of the uplink message overlapping with the time gap.

Aspect 14: The apparatus of any of aspects 1 through 13, wherein the at least one apparatus configured to apply the time gap between the uplink message and the one or more repetitions of the uplink message is further configured to: rate match the uplink message or the one or more repetitions of the uplink message when the time gap overlaps the uplink message or the one or more repetitions of the uplink message.

Aspect 15: An apparatus for wireless communication, comprising: a memory; and at least one processor coupled to the memory and configured to: receive information enabling one or more repetitions of an uplink message associated with a network access procedure, wherein a maximum bandwidth allocated to the apparatus is less than a bandwidth of an initial uplink bandwidth part of the apparatus; receive a frequency hopping indication for the one or more repetitions of the uplink message; transmit the uplink message and the one or more repetitions of the uplink message in different slots using inter-slot frequency hopping based on at least the information and the frequency hopping indication, wherein the inter-slot frequency hopping includes multiple portions of multiple sub-bands of the initial uplink bandwidth part, and wherein a single portion of the multiple portions is used in each of the different slots.

Aspect 16: The apparatus of aspect 15, wherein the frequency hopping indication includes a frequency hopping flag that enables or disables frequency hopping using the multiple portions of the multiple sub-bands.

Aspect 17: The apparatus of aspect 15 or 16, wherein the at least one processor is further configured to: determine a plurality of frequency hops for the inter-slot frequency hopping, wherein the plurality of frequency hops include multiple portions of a first sub-band and multiple portions of a second sub-band, and wherein each of the different slots is associated with one of the plurality of frequency hops based on a frequency hopping pattern.

Aspect 18: The apparatus of any of aspects 15 through 17, wherein the frequency hopping pattern indicates to use a first set of frequency hops associated with the first sub-band followed by a second set of frequency hops associated with the second sub-band, wherein the first set of frequency hops and the second set of frequency hops are included in the plurality of frequency hops.

Aspect 19: The apparatus of any of aspects 15 through 17, wherein the frequency hopping pattern indicates to use one of a first set of frequency hops associated with the first sub-band followed by one of a second set of frequency hops associated with the second sub-band, wherein the first set of frequency hops and the second set of frequency hops are included in the plurality of frequency hops.

Aspect 20: The apparatus of any of aspects 15 through 19, wherein the at least one processor is further configured to: receive control information indicating a number of the multiple sub-bands to be used for the inter-slot frequency hopping.

Aspect 21: The apparatus of any of aspects 15 through 20, wherein the at least one processor is further configured to: apply a time gap between the uplink message and the one or more repetitions of the uplink message to enable switching between the multiple sub-bands of the initial uplink bandwidth part.

Aspect 22: The apparatus of any of aspects 15 through 21, wherein a duration of the time gap is preconfigured at the apparatus or indicated in frequency hopping control information.

Aspect 23: The apparatus of any of aspects 15 through 22, wherein the time gap is applied in a current hop of the inter-slot frequency hopping or a next hop of the inter-slot frequency hopping.

Aspect 24: The apparatus of any of aspects 15 through 23, wherein the at least one apparatus configured to apply the time gap between the uplink message and the one or more repetitions of the uplink message is further configured to: puncture one or more portions of the uplink message or of the one or more repetitions of the uplink message overlapping with the time gap.

Aspect 25: The apparatus of any of aspects 15 through 24, wherein the at least one apparatus configured to apply the time gap between the uplink message and the one or more repetitions of the uplink message is further configured to: rate match the uplink message or the one or more repetitions of the uplink message when the time gap overlaps the uplink message or the one or more repetitions of the uplink message.

Aspect 26: A method of wireless communication, comprising: receiving information enabling one or more repetitions of an uplink message associated with a network access procedure, wherein a maximum bandwidth allocated to a user equipment (UE) is less than a bandwidth of an initial uplink bandwidth part of the UE; receiving a frequency hopping indication for the one or more repetitions of the uplink message; and transmitting the uplink message and the one or more repetitions of the uplink message in different slots using inter-slot frequency hopping based on at least the information and the frequency hopping indication, wherein the inter-slot frequency hopping includes multiple sub-bands of the initial uplink bandwidth part, and wherein a single sub-band of the multiple sub-bands is used in each of the different slots.

Aspect 27: The method of aspect 26, further comprising: determining at least a first frequency hop and a second frequency hop for the inter-slot frequency hopping, wherein the first frequency hop includes a first set of sub-bands of the multiple sub-bands and the second frequency hop includes a second set of sub-bands of the multiple sub-bands, wherein the first set of sub-bands are nonoverlapping with the second set of sub-bands, and wherein each of the different slots is associated with either the first frequency hop or the second frequency hop based on a frequency hopping pattern.

Aspect 28: The method of aspect 26 or 27, further comprising: receiving control information indicating a number of the multiple sub-bands to be used for the inter-slot frequency hopping.

Aspect 29: A method of wireless communication, comprising: receiving information enabling one or more repetitions of an uplink message associated with a network access procedure, wherein a maximum bandwidth allocated to a user equipment (UE) is less than a bandwidth of an initial uplink bandwidth part of the UE; receiving a frequency hopping indication for the one or more repetitions of the uplink message; and transmitting the uplink message and the one or more repetitions of the uplink message in different slots using inter-slot frequency hopping based on at least the information and the frequency hopping indication, wherein the inter-slot frequency hopping includes multiple portions of multiple sub-bands of the initial uplink bandwidth part, and wherein a single portion of the multiple portions is used in each of the different slots.

Aspect 30: The method of aspect 29, further comprising: determining a plurality of frequency hops for the inter-slot frequency hopping, wherein the plurality of frequency hops include multiple portions of a first sub-band and multiple portions of a second sub-band, and wherein each of the different slots is associated with one of the plurality of frequency hops based on a frequency hopping pattern.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. The term “hop” as used herein refers to a frequency hop and may be used interchangeably with the term frequency hop. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
receive information enabling one or more repetitions of an uplink message associated with a network access procedure, wherein a maximum bandwidth allocated to the apparatus is less than a bandwidth of an initial uplink bandwidth part of the apparatus;
receive a frequency hopping indication for the one or more repetitions of the uplink message; and
transmit the uplink message and the one or more repetitions of the uplink message in different slots using inter-slot frequency hopping based on at least the information and the frequency hopping indication, wherein the inter-slot frequency hopping includes multiple sub-bands of the initial uplink bandwidth part, and wherein a single sub-band of the multiple sub-bands is used in each of the different slots.

2. The apparatus of claim 1, wherein the frequency hopping indication includes a frequency hopping flag that enables or disables frequency hopping using the multiple sub-bands of the initial uplink bandwidth part.

3. The apparatus of claim 1, wherein the at least one processor is further configured to:
determine at least a first frequency hop and a second frequency hop for the inter-slot frequency hopping, wherein the first frequency hop includes a first set of sub-bands of the multiple sub-bands and the second frequency hop includes a second set of sub-bands of the multiple sub-bands, wherein the first set of sub-bands are nonoverlapping with the second set of sub-bands, and wherein each of the different slots is associated with either the first frequency hop or the second frequency hop based on a frequency hopping pattern.

4. The apparatus of claim 3, wherein the frequency hopping pattern alternates between the first frequency hop and the second frequency hop for successive slots of the different slots.

5. The apparatus of claim 3, wherein the frequency hopping pattern indicates the first frequency hop or the second frequency hop for each of the different slots based on an index value of each of the different slots.

6. The apparatus of claim 3, wherein the frequency hopping pattern indicates to use a lowest sub-band in the first set of sub-bands of the first frequency hop or the second set of sub-bands of the second frequency hop.

7. The apparatus of claim 3, wherein the frequency hopping pattern indicates to use a highest sub-band in the first set of sub-bands of the first frequency hop or the second set of sub-bands of the second frequency hop.

8. The apparatus of claim 3, wherein an initial set of resources of a sub-band of the multiple sub-bands is used for transmission of the uplink message or the one or more repetitions of the uplink message.

9. The apparatus of claim 1, wherein the at least one processor is further configured to:
receive control information indicating a number of the multiple sub-bands to be used for the inter-slot frequency hopping.

10. The apparatus of claim 1, wherein the at least one processor is further configured to:
apply a time gap between the uplink message and the one or more repetitions of the uplink message to enable switching between the multiple sub-bands of the initial uplink bandwidth part.

11. The apparatus of claim 10, wherein a duration of the time gap is preconfigured at the apparatus or indicated in frequency hopping control information.

12. The apparatus of claim 10, wherein the time gap is applied in a current hop of the inter-slot frequency hopping or a next hop of the inter-slot frequency hopping.

13. The apparatus of claim 10, wherein the at least one apparatus configured to apply the time gap between the uplink message and the one or more repetitions of the uplink message is further configured to:
puncture one or more portions of the uplink message or of the one or more repetitions of the uplink message overlapping with the time gap.

14. The apparatus of claim 10, wherein the at least one apparatus configured to apply the time gap between the uplink message and the one or more repetitions of the uplink message is further configured to:
rate match the uplink message or the one or more repetitions of the uplink message when the time gap overlaps the uplink message or the one or more repetitions of the uplink message.

15. An apparatus for wireless communication, comprising:
a memory; and
at least one processor coupled to the memory and configured to:
receive information enabling one or more repetitions of an uplink message associated with a network access procedure, wherein a maximum bandwidth allocated to the apparatus is less than a bandwidth of an initial uplink bandwidth part of the apparatus;
receive a frequency hopping indication for the one or more repetitions of the uplink message; and
transmit the uplink message and the one or more repetitions of the uplink message in different slots using inter-slot frequency hopping based on at least the information and the frequency hopping indication, wherein the inter-slot frequency hopping includes multiple portions of multiple sub-bands of the initial uplink bandwidth part, and wherein a single portion of the multiple portions is used in each of the different slots.

16. The apparatus of claim 15, wherein the frequency hopping indication includes a frequency hopping flag that enables or disables frequency hopping using the multiple portions of the multiple sub-bands.

17. The apparatus of claim 15, wherein the at least one processor is further configured to:
determine a plurality of frequency hops for the inter-slot frequency hopping, wherein the plurality of frequency hops include multiple portions of a first sub-band and multiple portions of a second sub-band, and wherein each of the different slots is associated with one of the plurality of frequency hops based on a frequency hopping pattern.

18. The apparatus of claim 17, wherein the frequency hopping pattern indicates to use a first set of frequency hops associated with the first sub-band followed by a second set of frequency hops associated with the second sub-band, wherein the first set of frequency hops and the second set of frequency hops are included in the plurality of frequency hops.

19. The apparatus of claim 17, wherein the frequency hopping pattern indicates to use one of a first set of frequency hops associated with the first sub-band followed by one of a second set of frequency hops associated with the second sub-band, wherein the first set of frequency hops and the second set of frequency hops are included in the plurality of frequency hops.

20. The apparatus of claim 15, wherein the at least one processor is further configured to:
receive control information indicating a number of the multiple sub-bands to be used for the inter-slot frequency hopping.

21. The apparatus of claim 15, wherein the at least one processor is further configured to:
apply a time gap between the uplink message and the one or more repetitions of the uplink message to enable switching between the multiple sub-bands of the initial uplink bandwidth part.

22. The apparatus of claim 21, wherein a duration of the time gap is preconfigured at the apparatus or indicated in frequency hopping control information.

23. The apparatus of claim 21, wherein the time gap is applied in a current hop of the inter-slot frequency hopping or a next hop of the inter-slot frequency hopping.

24. The apparatus of claim 21, wherein the at least one apparatus configured to apply the time gap between the uplink message and the one or more repetitions of the uplink message is further configured to:
puncture one or more portions of the uplink message or of the one or more repetitions of the uplink message overlapping with the time gap.

25. The apparatus of claim 21, wherein the at least one apparatus configured to apply the time gap between the uplink message and the one or more repetitions of the uplink message is further configured to:
rate match the uplink message or the one or more repetitions of the uplink message when the time gap overlaps the uplink message or the one or more repetitions of the uplink message.

26. A method of wireless communication, comprising:
receiving information enabling one or more repetitions of an uplink message associated with a network access procedure, wherein a maximum bandwidth allocated to a user equipment (UE) is less than a bandwidth of an initial uplink bandwidth part of the UE;
receiving a frequency hopping indication for the one or more repetitions of the uplink message; and
transmitting the uplink message and the one or more repetitions of the uplink message in different slots using inter-slot frequency hopping based on at least the information and the frequency hopping indication, wherein the inter-slot frequency hopping includes multiple sub-bands of the initial uplink bandwidth part, and wherein a single sub-band of the multiple sub-bands is used in each of the different slots.

27. The method of claim 26, further comprising:
determining at least a first frequency hop and a second frequency hop for the inter-slot frequency hopping, wherein the first frequency hop includes a first set of sub-bands of the multiple sub-bands and the second frequency hop includes a second set of sub-bands of the multiple sub-bands, wherein the first set of sub-bands are nonoverlapping with the second set of sub-bands, and wherein each of the different slots is associated with either the first frequency hop or the second frequency hop based on a frequency hopping pattern.

28. The method of claim 26, further comprising:
receiving control information indicating a number of the multiple sub-bands to be used for the inter-slot frequency hopping.

29. A method of wireless communication, comprising:
receiving information enabling one or more repetitions of an uplink message associated with a network access procedure, wherein a maximum bandwidth allocated to a user equipment (UE) is less than a bandwidth of an initial uplink bandwidth part of the UE;
receiving a frequency hopping indication for the one or more repetitions of the uplink message; and
transmitting the uplink message and the one or more repetitions of the uplink message in different slots using inter-slot frequency hopping based on at least the information and the frequency hopping indication, wherein the inter-slot frequency hopping includes multiple portions of multiple sub-bands of the initial uplink bandwidth part, and wherein a single portion of the multiple portions is used in each of the different slots.

30. The method of claim 29, further comprising:
determining a plurality of frequency hops for the inter-slot frequency hopping, wherein the plurality of frequency hops include multiple portions of a first sub-band and multiple portions of a second sub-band, and wherein each of the different slots is associated with one of the plurality of frequency hops based on a frequency hopping pattern.
